(19) United States
(12) Patent Application Publication
(10) Pub. No.: US 2012/0264455 A1
(43) Pub. Date: Oct. 18, 2012

(54) BASE STATION, COMMUNICATION SYSTEM, AND COMMUNICATION METHOD

(75) Inventor: Hirotomo Yasuoka, Kawasaki (JP)

(73) Assignee: FUJITSU LIMITED, Kawasaki-shi (JP)

(21) Appl. No.: 13/432,233

(22) Filed: Mar. 28, 2012

(30) Foreign Application Priority Data
Mar. 30, 2011 (JP) 2011-075496

(51) Int. Cl. H04W 4/02

(52) U.S. Cl. 455/456.2

(57) ABSTRACT

A base station includes a transmission and reception section configured to receive a position registration request transmitted from a mobile station, and receive load information indicating a load of processing in each of a plurality of higher-level stations, transmitted from each of the plurality of higher-level stations which are connected to the base station, and a control section configured to select a higher-level station to be notified of the position registration request based on the load information, the position registration request being notified to the selected higher-level station by the transmission and reception section.

### CROSS-REFERENCE TO RELATED APPLICATION

This application is based upon and claims the benefit of priority of the prior Japanese Patent Application No. 2011-075496, filed on Mar. 30, 2011, the entire contents of which are incorporated herein by reference.

### FIELD

The embodiments discussed herein are related to a base station, a communication system, and a communication method.

### BACKGROUND

A communication system such as Long Term Evolution (LTE) is, for example, configured so that multiple evolved NodeBs (eNBs) in multiple position registration areas are arranged under multiple Mobility Management Entities (MMEs). In the communication system, the eNBs in one position registration area are connected to the multiple MMEs controlling the eNBs in the multiple position registration areas over a network architecture called S1-Flex. The S1-Flex is a network architecture in which a single eNB is connected to multiple MMEs over an Internet Protocol (IP) network.

Specifically, the position registration areas in the communication system in the LTE are as follows: several MMEs have the same multiple position registration areas under their control to control the eNBs existing in the position registration areas. In addition, several hundreds of eNBs and several tens of thousands of pieces of User Equipment (UE) exist in one position registration area.

With the configuration of the communication system described above, since multiple MMEs are connected to a single eNB in one position registration area, it is possible to realize load balancing of the processing in the MMEs between the multiple MMEs. For example, each eNB cyclically notifies the multiple MMEs connected to the eNB of position registration requests from the pieces of UE in a round-robin manner to realize the load balancing of the processing in the MMEs between the multiple MMEs.

### SUMMARY

According to an aspect of the invention, a base station includes a transmission and reception section configured to receive a position registration request transmitted from a mobile station, and receive load information indicating a load of processing in each of a plurality of higher-level stations, transmitted from each of the plurality of higher-level stations which are connected to the base station, and a control section configured to select a higher-level station to be notified of the position registration request based on the load information, the position registration request being notified to the selected higher-level station by the transmission and reception section.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates the entire area to which a first embodiment is applied;

FIG. 2 illustrates an example of a position registration area to which the first embodiment is applicable;

FIG. 3 is a diagram illustrating an example of a hardware configuration and a functional block diagram of an MME in the first embodiment;

FIG. 4 illustrates an example of an own MME position registration information table in the MME in the first embodiment;

FIG. 5 is a diagram illustrating an example of a hardware configuration and a functional block diagram of an eNB in the first embodiment;

FIG. 6 illustrates an example of an each MME position registration information table in the eNB in the first embodiment;

FIG. 7 illustrates an example of a selection ratio information table in the eNB in the first embodiment;

FIG. 8 is a sequence chart in the first embodiment;

FIG. 9 is a sequence chart illustrating an operational process of acquiring position registration information in the first embodiment;

FIG. 10 illustrates a first example of the each MME position registration information table in the acquisition of the position registration information in the first embodiment;

FIG. 11 illustrates a second example of the each MME position registration information table in the acquisition of the position registration information in the first embodiment;

FIG. 12 illustrates a third example of the each MME position registration information table in the acquisition of the position registration information in the first embodiment;

FIG. 13 is a sequence chart illustrating an operational process of determining a selection ratio of the MME in a destination MME selection controller in the eNB in the first embodiment;

FIG. 14 is a sequence chart illustrating a position registration operation in the eNB in the first embodiment;

FIG. 15 is a diagram illustrating an example of a hardware configuration and a functional block diagram of an eNB in a second embodiment;

FIG. 16 is a sequence chart in the second embodiment;

FIG. 17 is a sequence chart illustrating an operational process of acquiring the position registration information in the second embodiment;

FIG. 18 illustrates a first example of the each MME position registration information table in the acquisition of the position registration information in the second embodiment;

FIG. 19 illustrates a second example of the each MME position registration information table in the acquisition of the position registration information in the second embodiment;

FIG. 20 illustrates a third example of the each MME position registration information table in the acquisition of the position registration information in the second embodiment;

FIG. 21 is a sequence chart illustrating a position registration operation in the eNB in the second embodiment;

FIG. 22 is a diagram illustrating an example of a hardware configuration and a functional block diagram of an eNB in a third embodiment;

FIG. 23 illustrates an example of an each MME position registration information table in the eNB in the third embodiment;

FIG. 24 is a sequence chart in the third embodiment;

FIG. 25 is a sequence chart illustrating an operational process of acquiring the position registration information in the third embodiment;

FIG. 26 illustrates a first example of the each MME position registration information table in the acquisition of the position registration information in the third embodiment;

FIG. 27 illustrates a second example of the each MME position registration information table in the acquisition of the position registration information in the third embodiment;

FIG. 28 is a sequence chart illustrating a position registration operation in the eNB in the third embodiment;

FIG. 29 illustrates an example of the each MME position registration information table in the position registration in the third embodiment;

FIG. 30 is a diagram illustrating an example of a hardware configuration and a functional block diagram of a MME in a fourth embodiment;

FIG. 31 is a diagram illustrating an example of a hardware configuration and a functional block diagram of an eNB in the fourth embodiment;

FIG. 32 illustrates an example of an each MME position registration information table in the eNB in the fourth embodiment;

FIG. 33 illustrates an example of a position registration count statistical information graph in the eNB in the fourth embodiment;

FIG. 34 is a diagram illustrating an example of a hardware configuration and a functional block diagram of a statistical information server in the fourth embodiment;

FIG. 35 illustrates an example of an entire area statistical information table in the statistical information server in the fourth embodiment;

FIG. 36 is a sequence chart in the fourth embodiment;

FIG. 37 is a sequence chart illustrating a process of updating the position registration count statistical information graph in the fourth embodiment;

FIG. 38 is a sequence chart illustrating an operational process of acquiring the position registration information in the fourth embodiment;

FIG. 39 illustrates a first example of the each MME position registration information table in the acquisition of the position registration information in the fourth embodiment;

FIG. 40 illustrates a second example of the each MME position registration information table in the acquisition of the position registration information in the fourth embodiment;

FIG. 41 illustrates a third example of the each MME position registration information table in the acquisition of the position registration information in the fourth embodiment;

FIG. 42 is a sequence chart illustrating an operational process of determining the selection ratio of the MME in the fourth embodiment;

FIG. 43 illustrates an example of the each MME position registration information table in the determination of the selection ratio of the MME in the fourth embodiment;

FIG. 44 illustrates an example of the selection ratio information table in the eNB in the fourth embodiment;

FIG. 45 is a sequence chart illustrating a position registration operation in the eNB in the fourth embodiment;

FIG. 46 illustrates an example of the each MME position registration information table in the position registration in the fourth embodiment; and

FIG. 47 is a sequence chart in a fifth embodiment.

### DESCRIPTION OF EMBODIMENTS

Base stations, communication systems, and communication methods according to embodiments will herein be described with reference to the attached drawings. The configurations illustrated in the embodiments with reference to the attached drawings are only examples and the embodiments are not limited to the illustrated configurations.

While inventing the present embodiments, observations were made regarding a related art. Such observations include the following, for example.

In a communication system such as LTE, when each eNB cyclically notifies the multiple MMEs connected to the eNB of the position registration requests from the pieces of UE in a round-robin manner, it may be difficult to realize the load balancing of the processing in the MMEs between the multiple MMEs in the following cases.

For example, it may be difficult to realize the load balancing of the processing in the MMEs between the multiple MMEs in a case in which one MME failed and the faulty MME is recovered after a given time. In this case, the eNBs connected to the faulty MME and multiple other MMEs cyclically notify only the MMEs that do not fail of the position registration requests from the pieces of UE while the faulty MME is down. Then, when the MME that is down is recovered, the eNBs cyclically notify the multiple MMEs including the recovered MME, connected to the eNBs, of the position registration requests from the pieces of UE. A difference is made between the position registration count of the MME that was down and the position registration counts of the MMEs that normally operate to inhibit sufficient load balancing between the multiple MMEs.

In addition, it may be difficult to realize the load balancing of the processing in the MMEs between the multiple MMEs also in a case in which an eNB which does not have the S1-Flex function or whose logic to select a position registration destination MME is different from that of the other eNBs exists in a position registration area. When an eNB that notifies only a specific MME of the position registration requests exists in a position registration area, a higher load is applied to the MME to be notified of the position registration requests, compared with the other MMEs having the position registration area under their control. In other words, a larger number of positions are registered on the specific MME and, thus, the multiple MMEs controlling the eNBs in the position registration area are varied in load.

Accordingly, in the above case, it may be difficult to realize the load balancing of the processing in the MMEs between the multiple MMEs even when the eNB cyclically notifies the multiple MMEs controlling the eNBs in the position registration area of the position registration requests from the pieces of UE in a round-robin manner.

Each piece of UE determines an MME to be used in the position registration and uses the determined MME to perform communication services including an audio service, a packet service, and a television (TV) telephone service. Accordingly, if the position registration of mobile stations is excessively performed to a specific MME, the amount of processing of the MME is increased to reduce the processing speed. As a result, the quality of the communication service may be adversely affected.

In addition, since each MME have many functions, such as a variety of control over an S1-U interface (between each eNB and a serving gateway (SGW) and storage and control of data about a larger number of eNBs connected to the own MME, it is not desired to add a new configuration, for example, in which each MME is caused to monitor the load status in the MMEs.

### First Embodiment

In a first embodiment, each base station connected to multiple higher-level stations includes a buffer that holds a position registration request received from each mobile station and position registration requests that are subsequently received. When a given time elapsed since the holding of the position registration requests was started in the buffer, the multiple higher-level stations are instructed to transmit load information indicating the loads of the processing in the respective higher-level station, higher-level stations to be notified of the held position registration requests are selected from the multiple higher-level stations based on the load information received in response to the transmission instruction, and the selected higher-level stations are notified of the position registration requests to realize the load balancing between the multiple higher-level stations.

Although each MME, each eNB, and each piece of UE are described as examples of the higher-level station, the base station, and the mobile station, respectively, and position registration information indicating the position registration count in each MME is described as an example of the load information in the following description, the embodiments are not limited to the above examples. In addition, the load in each MME is not limited to the position registration count.

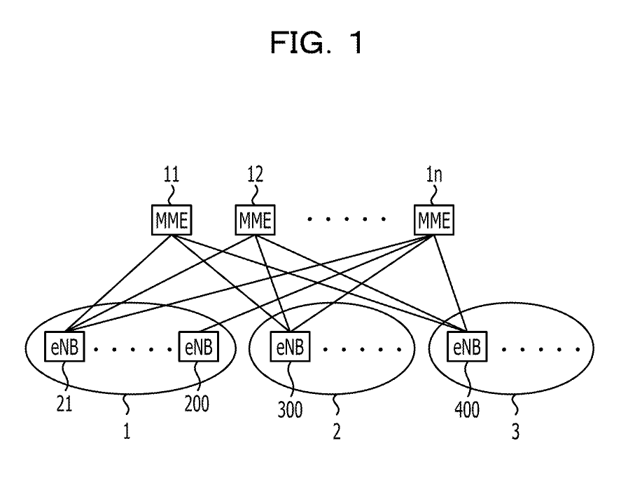

The first embodiment will now be described with reference to FIG. 1 to FIG. 14.

FIG. 1 illustrates the entire area to which the first embodiment is applied.

Referring to FIG. 1, multiple MMEs 11 to in have multiple position registration areas 1 to 3 under their control to control multiple eNBs existing in the respective position registration areas.

As illustrated in FIG. 1, the MMEs 11, 12, . . . , and in are connected to eNBs 21 to 200, eNBs 300 to . . . , and eNBs 400 to . . . in the position registration areas 1 to 3 in a mesh pattern to control each eNB. However, an eNB, such as the eNB 200, may exist which is not connected to all the MMEs having the position registration area 1 under their control. The first embodiment is applicable to the position registration area including the base station, such as the eNB 200. The position registration areas 1 to 3, the MME 11, 12, . . . , and 1n, and the eNBs 21 to 200, 300 to . . . , and 400 to . . . will be described below.

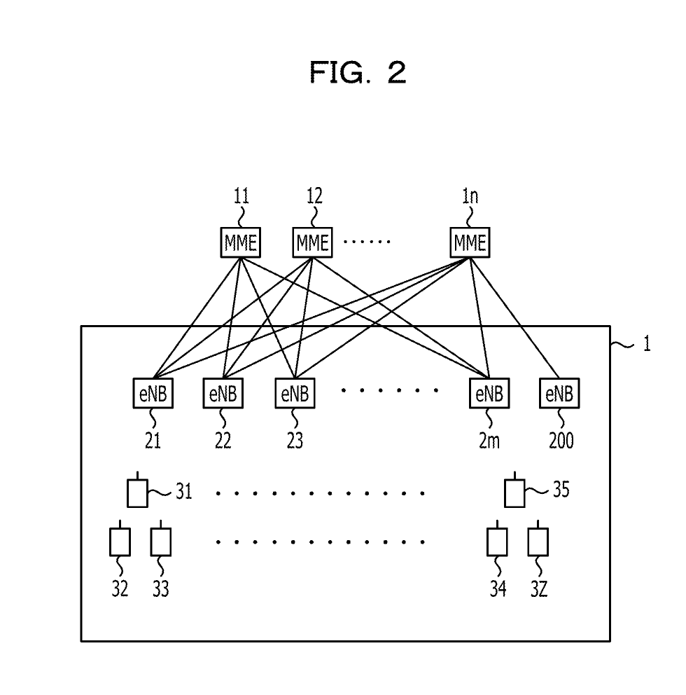

FIG. 2 illustrates an example of the position registration area 1 to which the first embodiment is applicable.

A base station, a communication system, and a communication method according to the first embodiment are applicable to the position registration area 1 illustrated in FIG. 2, which includes multiple eNBs 21 to 2m and 200. The eNBs 21 to 2m and 200 in the position registration area 1 are controlled by the multiple MMEs 11 to 11n.

The position registration area 1 is one position registration area, for example, among the multiple position registration areas controlled by about seven MMEs described below, and covers several hundreds of eNBs and several tens of thousands of pieces of UE. The position registration area 1 includes the multiple eNBs. In the first embodiment, the eNBs 21 to 2m and 200 and pieces of UE 31 to 3z exist in the position registration area 1 under the control of the MMEs 11 to 1n.

The MMEs 11 to in are each a major control node in an LTE access network and, for example, each have a security function concerning user data and protocols of non-access layers. In addition, in the first embodiment, the MMEs 11 to in each control the eNBs 21 to 2m connected to the MMEs 11 to in in a mesh pattern. The MME in controls the eNB 200, in addition to the eNBs 21 to 2m.

The eNBs 21 to 2m and 200 are each a base station supporting the LTE access network and have functions of a radio network controller (RNC) in related art, in addition to the functions of the base station. For example, the eNBs 21 to 2m and 200 have functions to control the basic operations of the UE, such as call reception control and handover, which are Radio Resource Management (RRM) and Radio Resource Control (RRC) functions, and functions to demultiplex, re-transmit, and align transmission and reception signals, which are Radio Link Control (RLC) and Media Access Control (MAC) functions. In addition, in the first embodiment, the eNBs 21 to 2m are each connected to the multiple MMEs 11 to 1n. The eNB 200 is connected only to the MME in and is not connected to the MMEs 11, 12, . . . controlling the eNBs 21 to 2m in the position registration area 1.

Each of the pieces of UE 31 to 3z is a mobile station. Each of the pieces of UE 31 to 3z newly detects that the UE exists in the position registration area 1 if a signal including area information is received from the eNBs 21 to 2m when the UE moves from another position registration area to the position registration area 1 or if the signal including the area information received from the eNBs 21 to 2m is different from positional information in the own UE when each of the pieces of UE 31 to 3z is switched from a power-off state to a power-on state in the position registration area 1. In other words, each of the pieces of UE 31 to 3z notifies the eNBs 21 to 2m of the position registration request when it is newly detected that the UE exists in the position registration area 1. The eNB which the pieces of UE 31 to 3z are to notify of the position registration requests transmits the position registration requests to the eNBs covering the pieces of UE 31 to 3z, among the eNBs 21 to 2m.

In a position registration method according to the first embodiment, each of the eNBs 21 to 2m transmits the position registration request to the MMEs 11 to in upon reception of the position registration request from the pieces of UE 31 to 3z. The eNB 200 notifies the MME in to which the eNB 200 is connected of the position registration request upon reception of the position registration request from the pieces of UE 31 to 3z.

The position registration of the pieces of UE 31 to 3z is realized by the above processing.

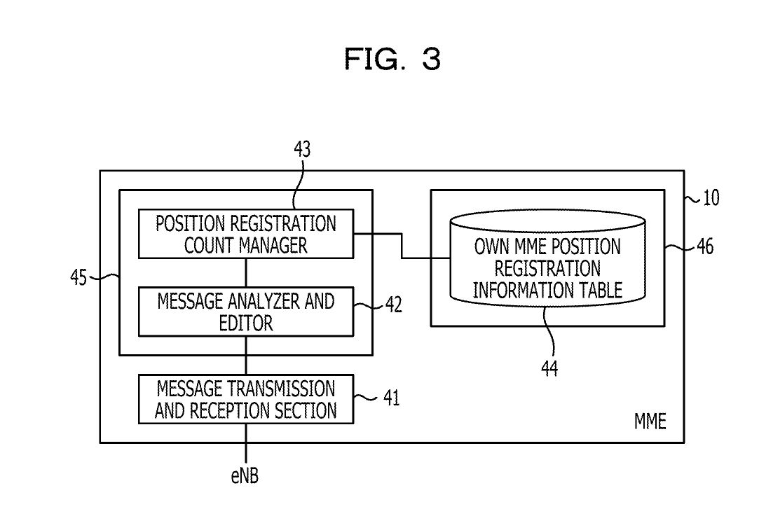

FIG. 3 is a diagram illustrating an example of a hardware configuration and a functional block diagram of the MME in the first embodiment.

Referring to FIG. 3, an MME 10 (the MMEs 11 to in are collectively referred to as the MME 10) includes a message transmission and reception section 41, a central processing unit (CPU) 45, and a memory 46.

The CPU 45 includes functional modules including a message analyzer and editor 42 and a position registration count manager 43. The memory 46 includes an own MME position registration information table 44.

The CPU 45 is an exemplary component that controls various functional modules. The CPU 45 executes an operating system (OS) and application programs stored in the memory to, for example, control the various functional modules and read out and write data from and into the memory.

The memory 46 is composed of a recording medium and includes, for example, a read only memory (ROM) and a random access memory (RAM). The OS, the application programs for a variety of processing, etc. are recorded in the ROM. The RAM includes a working area in which the OS and the application programs are decomposed.

The message transmission and reception section 41 transmits the position registration information indicating the position registration count in the MME 10 and receives the position registration request transmitted from a UE 30 (the pieces of UE 31 to 3z are collectively referred to as the UE 30) from an eNB 20 (the eNB 21 to 2m and 200 are collectively referred to as the eNB 20). The message transmission and reception section 41 receives, for example, a message concerning the position registration request transmitted from the UE 30 from the eNB 20 and transmits, for example, the position registration information indicating the position registration count in the MME 10 to the eNB 20.

The message analyzer and editor 42 analyzes a message received from the eNB 20 and edits a message to be transmitted to the eNB 20.

The position registration count manager 43 manages a current position registration count and a maximum allowable position registration count by using the own MME position registration information table 44 described below.

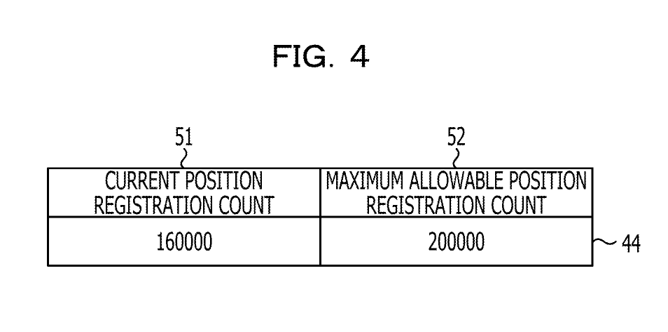

The current position registration count and the maximum allowable position registration count in the MME 10 are recorded in the own MME position registration information table 44. For example, as illustrated in FIG. 4, a current position registration count 51 and a maximum allowable position registration count 52 are stored in the own MME position registration information table 44 in association with each other. The current position registration count 51 indicates the position registration count currently registered in the MME 10. The maximum allowable position registration count 52 is a maximum position registration count that may be registered in the MME 10.

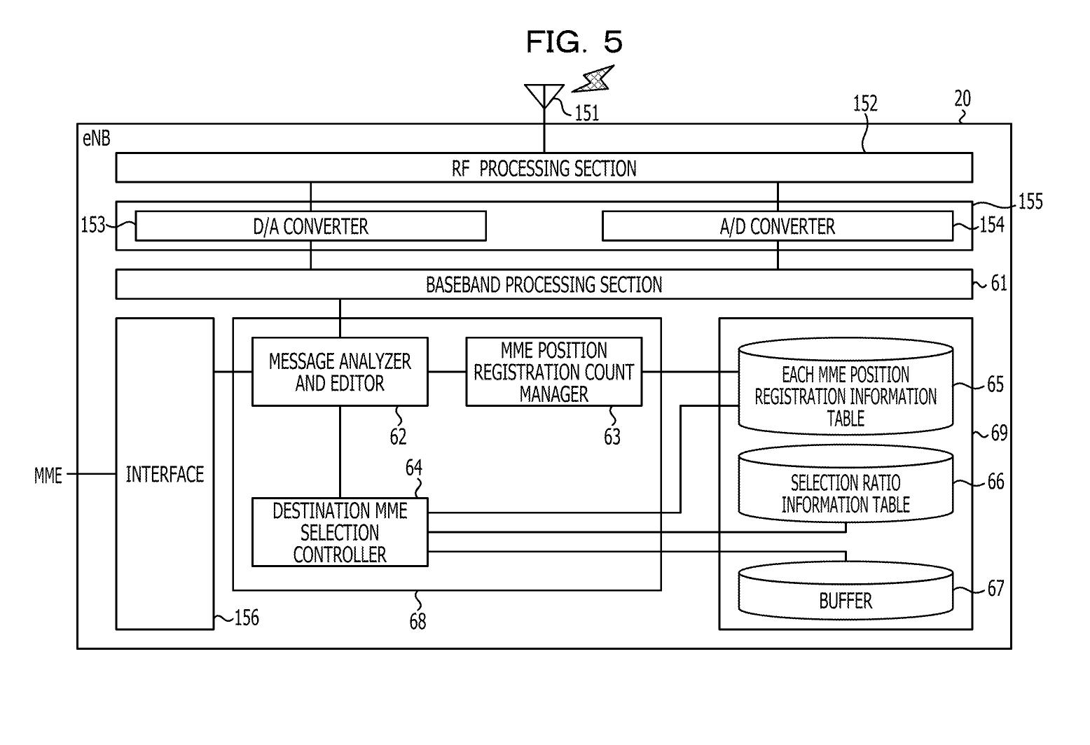

FIG. 5 is a diagram illustrating an example of a hardware configuration and a functional block diagram of the eNB in the first embodiment.

Referring to FIG. 5, the eNB 20 includes an antenna 151, a radio-frequency (RF) processing section 152, a conversion processing section 155, an interface 156, a baseband processing section 61, a CPU 68, and a memory 69.

The conversion processing section 155 includes a digital-to-analog (DA) converter 153 and an analog-to-digital (AD) converter 154. The CPU 68 includes functional modules including a message analyzer and editor 62, an MME position registration count manager 63, and a destination MME selection controller 64. The memory 69 includes an each MME position registration information table 65, a selection ratio information table 66, and a buffer 67.

The antenna 151 transmits a transmission signal supplied from the RF processing section 152 to the UE 30 by using radio waves as media and receives a signal transmitted from the UE 30 by using radio waves as media to supply the reception signal to the RF processing section 152.

The RF processing section 152 converts a data signal to be transmitted by a certain communication method into a high-frequency signal to transmit the high-frequency signal through the antenna 151 and converts a high-frequency signal received through the antenna 151 into a data signal. In the present embodiment, the RF processing section 152 receives the position registration request transmitted from the UE 30.

The conversion processing section 155 converts a signal to be transmitted into an analog signal with the DA converter 153 and converts a signal that is received into a digital signal with the AD converter 154.

The baseband processing section 61 performs baseband processing, such as encoding of a downstream signal and decoding of an upstream signal.

The interface 156 is used to receive the position registration information indicating the position registration count in the MME 10, transmitted from each of the multiple MMEs 10, and to notify the MME selected in the destination MME selection controller 64 described below of the position registration request. In the present embodiment, the interface 156 is used to receive, for example, the position registration information concerning the position registration count from the MME 10 and to transmit the position registration request from the UE 30 to the MME 10.

The message analyzer and editor 62 analyzes a message received through the antenna 151, the RF processing section 152, the conversion processing section 155, and the baseband processing section 61 and a message received through the interface 156 to identify the type of each message.

In addition, the message analyzer and editor 62 supplies a message including information to be transmitted to the baseband processing section 61 and the interface 156.

The MME position registration count manager 63 manages the current position registration count, the maximum allowable position registration count, etc. of each MME based on the position registration information indicating the position registration count, notified from each MME.

The destination MME selection controller 64 selects an MME to be notified of the position registration request based on the position registration information. In the present embodiment, the destination MME selection controller 64 selects an MME to which the position registration request received from the UE 30 is to be transmitted based on the position registration information indicating the position registration count, notified from the MME 10, and supplies the result of the selection to the message analyzer and editor 62.

The current position registration count, the maximum allowable position registration count, etc. of each MME are recorded in the each MME position registration information table 65.

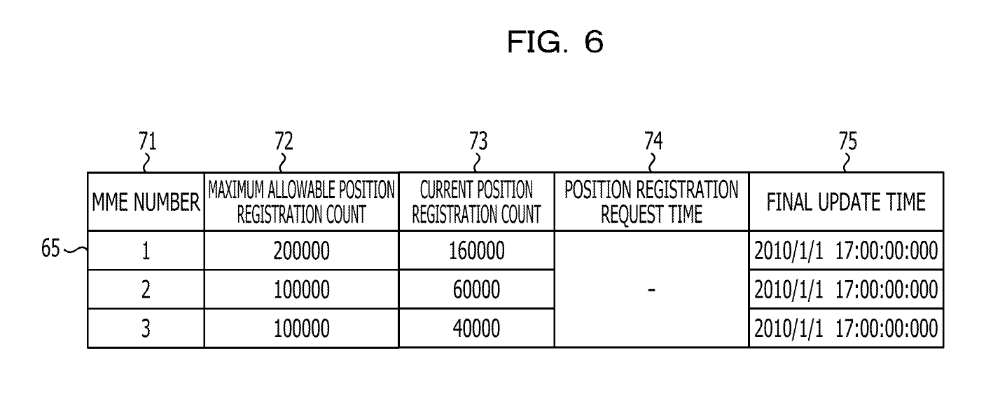

For example, as illustrated in FIG. 6, an MME number 71, a maximum allowable position registration count 72, a current position registration count 73, a position registration request time 74, and a final update time 75 are stored in the each MME position registration information table 65 in association with each other. The MME number 71 indicates a number with which each MME is identified. The maximum allowable position registration count 72 indicates the maximum position registration count that may be registered in the MME 10. The current position registration count 73 indicates the position registration count when the position registration requests received from all the eNBs connected to the MME 10 are accepted. The position registration request time 74 indicates the time when the position registration request is notified from the UE 30. The final update time 75 indicates the final time when the eNB 20 receives the position registration information described below from each MME.

Selection ratio information about the MME selected by the destination MME selection controller 64 is recorded in the selection ratio information table 66.

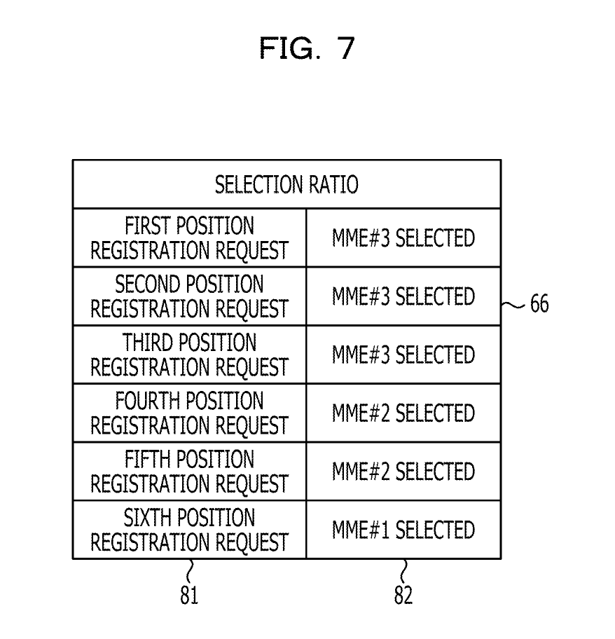

For example, as illustrated in FIG. 7, a position registration request count 81 and a position registration destination MME 82 are stored in the selection ratio information table 66 in association with each other. In the example in FIG. 7, the eNB 20 transmits the position registration request to the MME #3 at the first time when the position registration request is read out from the buffer 67 described below.

The buffer 67 holds the position registration request received by the RF processing section 152 and position registration requests that are subsequently received. In the present embodiment, the buffer 67 accumulates the position registration requests notified from the UE 30 and, after the position registration requests are accumulated for a given time, reads out the accumulated position registration requests under the control of the destination MME selection controller 64.

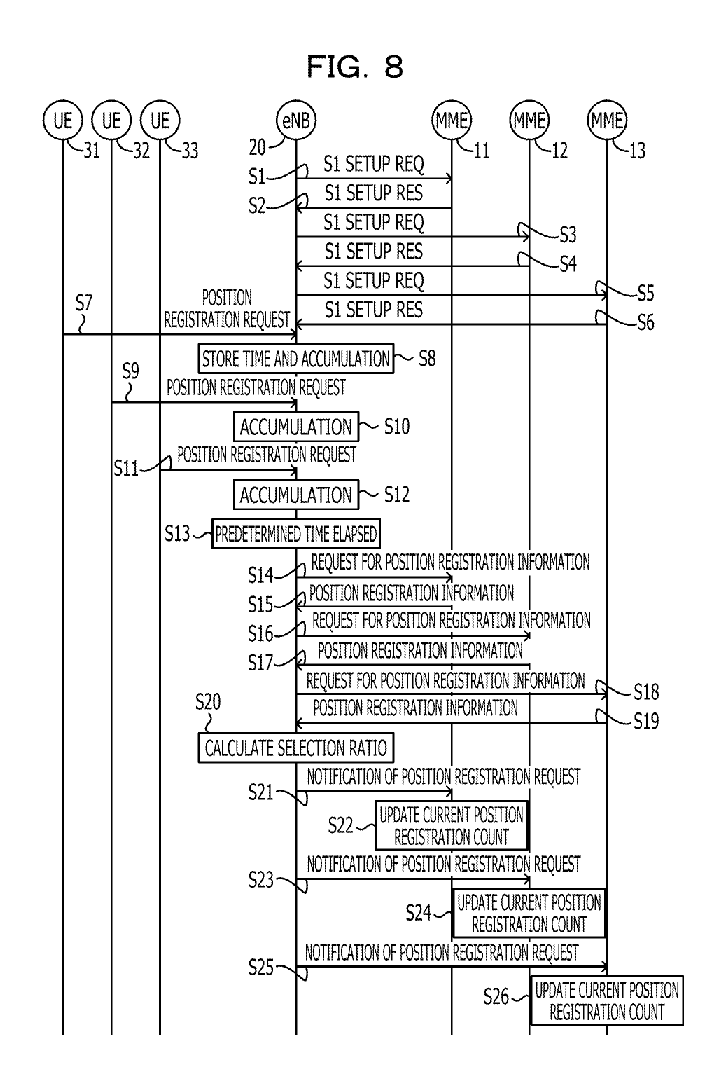

FIG. 8 is a sequence chart in the first embodiment.

Referring to FIG. 8, in S1, the eNB 20 transmits an S1 interface establishment request (S1 SETUP REQ) to the MME 11.

In S2, the MME 11 returns an S1 interface establishment response (S1 SETUP RES) to the eNB 20 upon reception of the S1 interface establishment request (S1 SETUP REQ) from the eNB 20 to establish an S1 interface.

In S3, the eNB 20 transmits the S1 interface establishment request (S1 SETUP REQ) to the MME 12.

In S4, the MME 12 returns the S1 interface establishment response (S1 SETUP RES) to the eNB 20 upon reception of the S1 interface establishment request (S1 SETUP REQ) from the eNB 20 to establish the S1 interface.

In S5, the eNB 20 transmits the S1 interface establishment request (S1 SETUP REQ) to the MME 13.

In S6, the MME 13 returns the S1 interface establishment response (S1 SETUP RES) to the eNB 20 upon reception of the S1 interface establishment request (S1 SETUP REQ) from the eNB 20 to establish the S1 interface.

The eNB 20 is connected to the MMEs 11 to 13 in a mesh pattern through S1 to S6 to achieve the S1-Flex function.

In S7, the eNB 20 receives the position registration request from the UE 31. In S8, the eNB 20 stores the time when the position registration request is notified from the UE 31 as the position registration request time 74 in the each MME position registration information table 65 in FIG. 6 and accumulates the position registration request in the buffer 67.

In S9, the eNB 20 receives the position registration request from the UE 32. In S10, the eNB 20 accumulates the position registration request in the buffer 67.

In S11, the eNB 20 receives the position registration request from the UE 33. In S12, the eNB 20 accumulates the position registration request in the buffer 67.

In S13, the eNB 20 determines that a given time elapsed since the time (the position registration request time 74 in the each MME position registration information table 65 in FIG. 6) when the first position registration request is received.

In S14, the eNB 20 inquires of the MME 11 about the position registration information.

In S15, the MME 11 notifies the eNB 20 of the position registration information including the maximum allowable position registration count and the current position registration count.

In S16, the eNB 20 inquires of the MME 12 about the position registration information.

In S17, the MME 12 notifies the eNB 20 of the position registration information including the maximum allowable position registration count and the current position registration count.

In S18, the eNB 20 inquires of the MME 13 about the position registration information.

In S19, the MME 13 notifies the eNB 20 of the position registration information including the maximum allowable position registration count and the current position registration count.

In S20, upon notification of the position registration information from all the MMEs establishing the S1 interface with the eNB 20, the eNB 20 calculates a selection ratio in the selection of the MME to be notified of the position registration request based on the position registration information.

In S21, if the calculated selection ratio indicates that the MME to be notified of the position registration request that is first read out is the MME 11, the eNB 20 allocates the position registration request that is first received from the UE 31, among the position registration requests accumulated in the buffer 67, to the MME 11 and notifies the MME 11 of the allocated position registration request.

In S22, the MME 11 updates the current position registration count 51 in the own MME position registration information table 44 after the position registration.

In S23, if the calculated selection ratio indicates that the MME to be notified of the second position registration request that is read out is the MME 12, the eNB 20 allocates the second position registration request that is received from the UE 32, among the position registration requests accumulated in the buffer 67, to the MME 12 and notifies the MME 12 of the allocated position registration request.

In S24, the MME 12 updates the current position registration count 51 in the own MME position registration information table 44 after the position registration.

In S25, if the calculated selection ratio indicates that the MME to be notified of the third position registration request that is read out is the MME 13, the eNB 20 allocates the third position registration request that is received from the UE 33, among the position registration requests accumulated in the buffer 67, to the MME 13 and notifies the MME 13 of the allocated position registration request.

In S26, the MME 13 updates the current position registration count 51 in the own MME position registration information table 44 after the position registration.

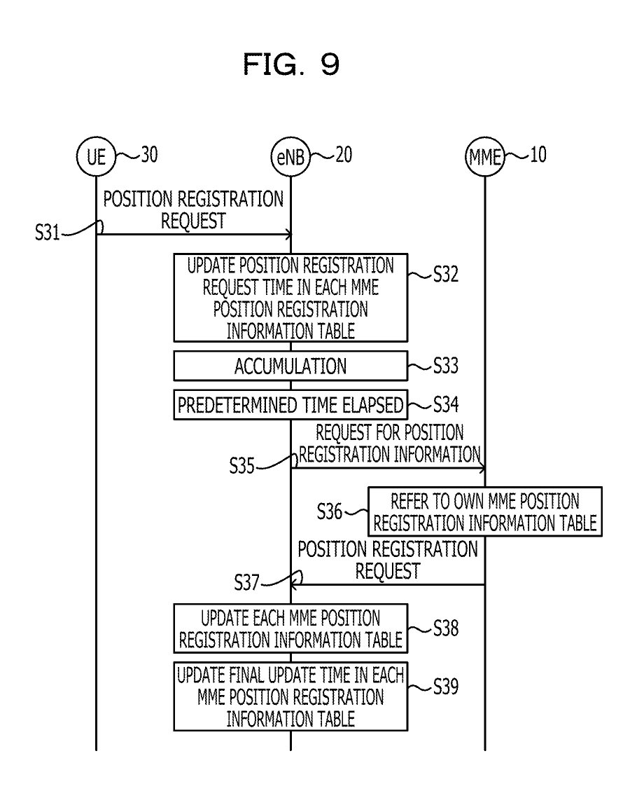

Operations according to the first embodiment will now be described in detail with reference to FIG. 9 to FIG. 14.

FIG. 9 is a sequence chart illustrating an operational process of acquiring the position registration information indicating the position registration count when the position registration request is submitted in the first embodiment.

Referring to FIG. 9, in S31, the eNB 20 receives a message (the position registration request) transmitted from the UE 30. The eNB 20 supplies the message to the message analyzer and editor 62 through the RF processing section 152, the AD converter 154, and the baseband processing section 61. The message analyzer and editor 62 analyzes the supplied message and, if the analysis indicates that the message is the position registration request, notifies the destination MME selection controller 64 of the position registration request.

In S32, the destination MME selection controller 64 updates the position registration request time 74 in the each MME position registration information table 65 to the time when the position registration request transmitted from the UE 30 is notified.

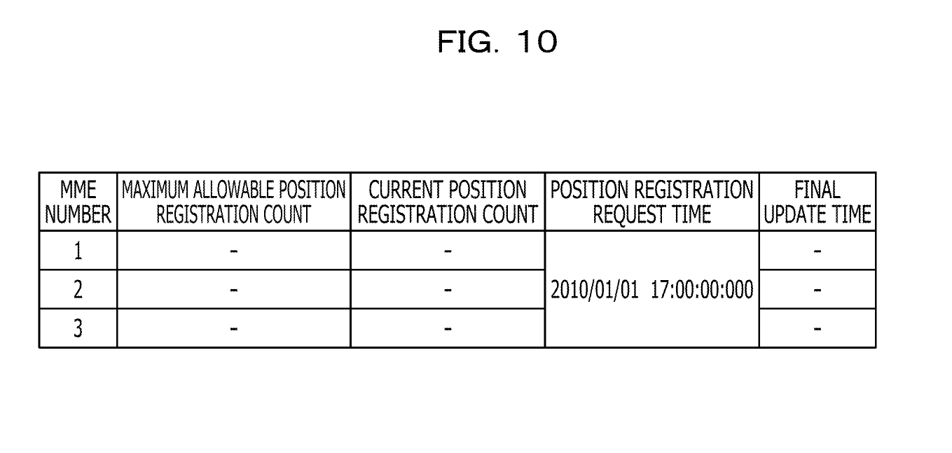

For example, FIG. 10 illustrates an example of the each MME position registration information table 65 when the position registration request is notified from the UE 30 in S32. In the example in FIG. 10, the position registration request is notified from the UE 30 at Jan. 1, 2010 17:00:00:000.

In S33, the destination MME selection controller 64 accumulates the position registration request in the buffer 67.

In S34, the destination MME selection controller 64 refers to the position registration request time 74 in the each MME position registration information table 65 and, as the result of comparison between the position registration request time 74 and the current time, determines that the position registration requests have been accumulated in the buffer 67 for a given time. Then, the destination MME selection controller 64 notifies the message analyzer and editor 62 that the position registration requests have been accumulated in the buffer 67 for the given time. For example, when it is assumed that about 50 position registration requests are transmitted from the UE per second, it is desirable that the position registration requests be accumulated for a time period from 0.5 seconds to one second. In other words, during the above time period, it is possible to perform the processing according to the present embodiment without an adverse effect, such as the UE that is incommunicable, even if the position registration is not performed while the position registration requests are held.

In S35, the message analyzer and editor 62 edits the message for request for the position registration information and transmits the edited message to the respective MMEs establishing the S1 interface as a request for the position registration information through the interface 156.

Upon reception of the message (the request for the position registration information) from the eNB 20, the message transmission and reception section 41 in the MME 10 notifies the message analyzer and editor 42 of the message (the request for the position registration information). The message analyzer and editor 42 analyzes the message notified from the message transmission and reception section 41. If the analysis indicates that the message is the request for the position registration information, the message analyzer and editor 42 inquires of the position registration count manager 43 about the position registration information about the own MME. In S36, upon reception of the inquiry, the position registration count manager 43 refers to the own MME position registration information table 44 to notify the message analyzer and editor 42 of the current position registration count 51 and the maximum allowable position registration count 52 in the own MME.

In S37, the message analyzer and editor 42 transmits the position registration information including the current position registration count 51 and the maximum allowable position registration count 52 to the eNB 20 as the message through the message transmission and reception section 41.

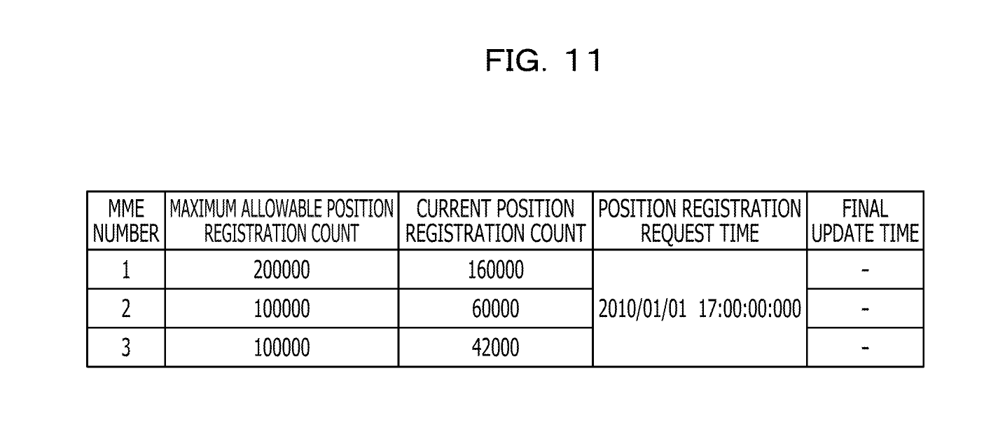

The eNB 20 supplies the message received from the MME 10 to the message analyzer and editor 62 through the interface 156. The message analyzer and editor 62 analyzes the supplied message and, if the analysis indicates that the message is the position registration information, extracts the current position registration count 51 and the maximum allowable position registration count 52 from the position registration information. Then, the message analyzer and editor 62 supplies the extracted information to the MME position registration count manager 63. In S38, the MME position registration count manager 63 updates the each MME position registration information table 65 for every MME based on the information supplied from the message analyzer and editor 62. FIG. 11 illustrates an example of the each MME position registration information table 65 in S38.

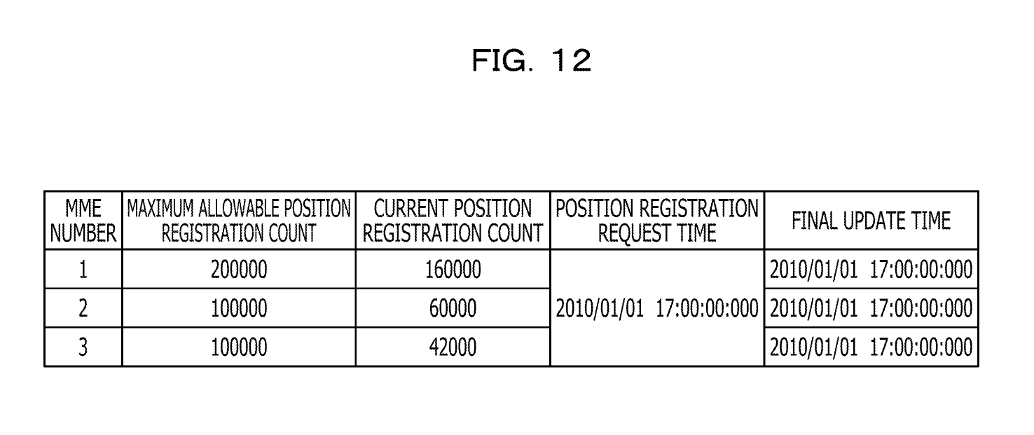

In S39, the MME position registration count manager 63 updates the final update time 75 in the each MME position registration information table 65 to the time when the position registration information is received from the MME 10. FIG. 12 illustrates an example of the each MME position registration information table 65 in S39.

The each MME position registration information table 65 in FIG. 12 indicates that the eNB connected to the MMEs #1, #2, and #3 received the position registration information from each MME at Jan. 1, 2010 17:10:00:000. The MME #1 may register up to 200,000 positions and 160,000 positions are registered in the MME #1 at Jan. 1, 2010 17:00:00:000 in the example in FIG. 12.

The storage of the position registration request in the buffer for a given time in the above manner allows the number of times when the eNB is notified of the position registration information to be decreased, thereby reducing the load on the MMEs.

In the establishment of the S1 interface, the MME 10 may transmit the message, which is the position registration information, to the eNB.

With the above method, it is possible to perform the position registration to the optimal MME without another request for the position registration information when the position registration request is submitted from the UE immediately after the S1 interface is established.

S31, S33, S34, S35, and S37 in FIG. 9 correspond to S7, S8, S13, S14, and S15 in FIG. 8, respectively.

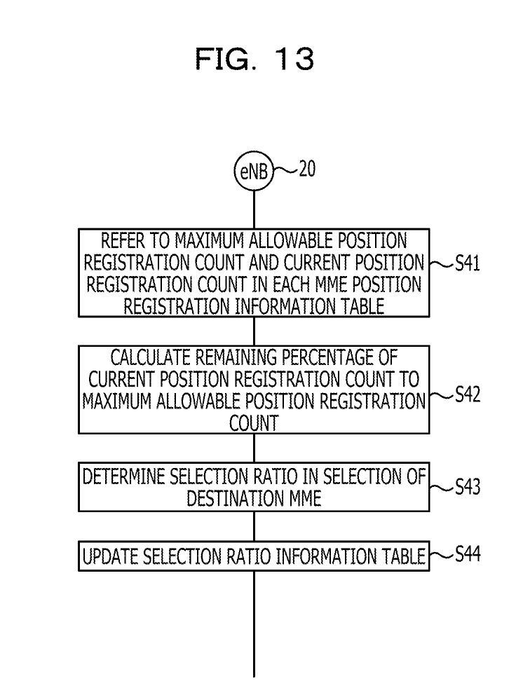

FIG. 13 is a sequence chart illustrating an operational process of determining the selection ratio of the MME in the destination MME selection controller 64 in the eNB 20 in the first embodiment.

Referring to FIG. 13, after the position registration information is acquired from each MME and the each MME position registration information table 65 is updated, in S41, the destination MME selection controller 64 refers to the maximum allowable position registration count 72 and the current position registration count 73 of each MME in the each MME position registration information table 65. In order to know the load status in the position registration in each MME, in S42, the destination MME selection controller 64 calculates the percentage in the position registration (the remaining percentage) by using the maximum allowable position registration count 72 and the current position registration count 73 of each MME based on the result of the reference to the each MME position registration information table 65.

For example, the percentage in the position registration (the remaining percentage) may be calculated by the following equation: the percentage (the remaining percentage)=1−the current position registration count/the maximum allowable position registration count.

The percentage (the remaining percentage) of the current position registration count 73 to the maximum allowable position registration count 72 of each MME is calculated by using the above equation. The calculation of the remaining percentage of the current position registration count 73 to the maximum allowable position registration count 72 of each MME from the maximum allowable position registration count 72 and the current position registration count 73 of each MME in the example of the each MME position registration information table 65 in FIG. 12 results in the MME #1=0.2, the MME #2=0.4, and the MME #3=0.6. The above operations (S41 and S42) are performed to all the MMEs establishing the S1 interface with the eNB.

In S43, the destination MME selection controller 64 determines the selection ratio in the selection of the destination MME so that load balancing of the position registration counts in the respective MME is uniformly performed.

For example, the selection ratio may be determined in a manner described below.

Calculation of the proportion of the remaining percentages calculated for the respective MMEs in order to determine the selection ratio results in the MME #1:the MME #2:the MME #3=0.2:0.4:0.6=1:2:3.

The MME to be notified of the position registration request is determined based on this proportion. In the above example, if the position registration requests corresponding to six calls are submitted, one call is allocated to the MME #1, two calls are allocated to the MME #2, and three calls are allocated to the MME #3.

In S44, the destination MME selection controller 64 updates the selection ratio information table 66 based on the calculated selection ratio.

The MMEs may be selected in descending order of the selection ratio or the selection order may not be determined.

The determination of the selection ratio, the update of the selection ratio information table, etc. described above are performed, for example, immediately before the position registration requests accumulated in the buffer 67 are read out or immediately after the position registration requests are received from all the MMEs.

S43 in FIG. 13 corresponds to S20 in FIG. 8.

The selection ratio of the MMEs is calculated by the destination MME selection controller 64 and the MME to be notified of the position registration request received from the UE 30 is selected based on the result of the calculation in the above manner to balance the loads of the respective MMEs in the position registration.

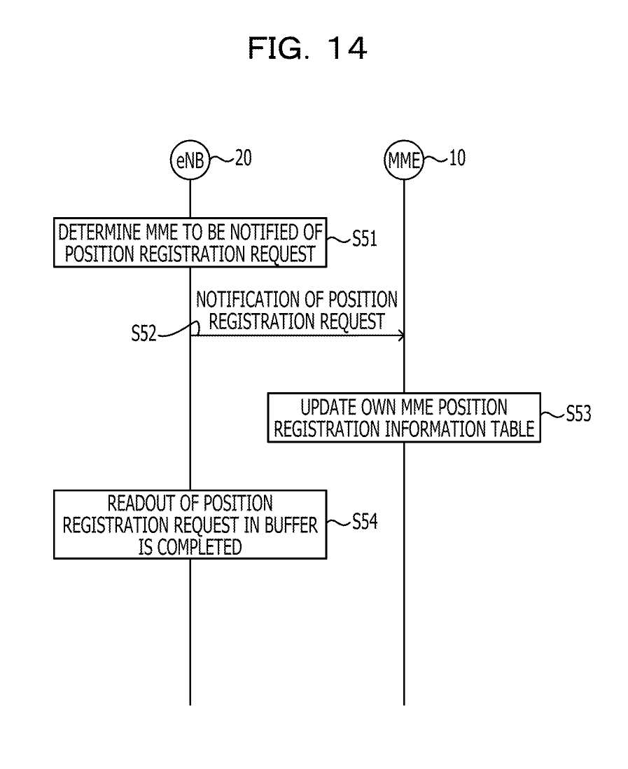

FIG. 14 is a sequence chart illustrating a position registration operation in the eNB 20 in the first embodiment.

Referring to FIG. 14, in S51, the destination MME selection controller 64 determines the MMEs to be notified of all the position registration requests accumulated in the buffer 67 based on the selection ratio information table 66 and supplies the MME numbers of the determined MMEs to be notified of the position registration requests to the message analyzer and editor 62.

Upon reception of the MME number of the MME to be notified of each position registration request, the message analyzer and editor 62 edits the message used for transmission of the position registration request to the MME indicated by the MME number and supplies the message to the interface 156. In S52, the interface 156 transmits the message supplied from the message analyzer and editor 62 to the MME indicated by the MME number as the position registration request.

Upon reception of the message from the eNB 20, the message transmission and reception section 41 in the MME 10 supplies the message to the message analyzer and editor 42. The message analyzer and editor 42 analyzes the message supplied from the message transmission and reception section 41 and, if the message is the position registration request, supplies the position registration request to the position registration count manager 43.

In S53, upon reception of the position registration request from the message analyzer and editor 42, the position registration count manager 43 registers the position of the UE 30 to which the supplied position registration request is transmitted and updates the current position registration count 51 in the own MME position registration information table 44.

In S54, the destination MME selection controller 64 in the eNB 20 stops the determination of the MME to be notified of the position registration request using the current selection ratio information table 66 when the readout of all the position registration requests in the buffer 67 is completed.

S51 in FIG. 14 corresponds to S20 in FIG. 8, S52 in FIG. 14 corresponds to S21, S23, and S25 in FIG. 8, and S53 in FIG. 14 corresponds to S22, S24, and S26 in FIG. 8.

According to the first embodiment, even if any eNB exists which is to notify part of MMEs, among the MMEs that have the same position registration area under their control and that control the eNBs in the position registration area, of the position registration requests from the pieces of UE, the eNB of the present embodiment determines the MME to be notified of the position registration request so that the position registration counts are balanced between the respective MMEs to balance the load between the MMEs having the same position registration area under their control.

Although the position registration requests are stored in the buffer in the eNB for a given time in the first embodiment, the accumulation may be continued until the position registration requests of a given number are accumulated in the buffer.

Specifically, in the first embodiment, each base station connected to multiple higher-level stations includes a buffer that holds the position registration request received from each mobile station and the position registration requests that are subsequently received. When the position registration requests of a given number are held in the buffer, the multiple higher-level stations may be instructed to transmit the load information indicating the load of the processing in each higher-level station, higher-level stations to be notified of the held position registration requests may be selected from the multiple higher-level stations based on the load information received in response to the transmission instruction, and the selected higher-level stations may be notified of the held position registration requests to realize the load balancing between the multiple higher-level stations.

Since the eNB may collectively notify each MME of the position registration requests of a certain number with the above method, it is possible to decrease the number of times when the eNB requests transmission of the position registration information, the number of times when the MME transmits the position registration information, and the number of times when the eNB notifies the MMEs of the position registration requests. Accordingly, the load of the processing on the eNBs and the MMEs is reduced.

### Second Embodiment

In a second embodiment, upon start of reception of the position registration requests by each base station, multiple higher-level stations are instructed to transmit the load information, higher-level stations to be notified of the position registration requests received for a given time since the reception of the position registration requests has been started are selected from the multiple higher-level stations based on the load information received in response to the transmission instruction, and the selected higher-level stations are notified of the position registration requests to realize the load balancing between the multiple higher-level stations.

Although each MME, each eNB, and each piece of UE are described as examples of the higher-level station, the base station, and the mobile station, respectively, and the position registration information indicating the position registration count in each MME is described as an example of the load information in the following description, the load on each MME is not limited to the position registration count.

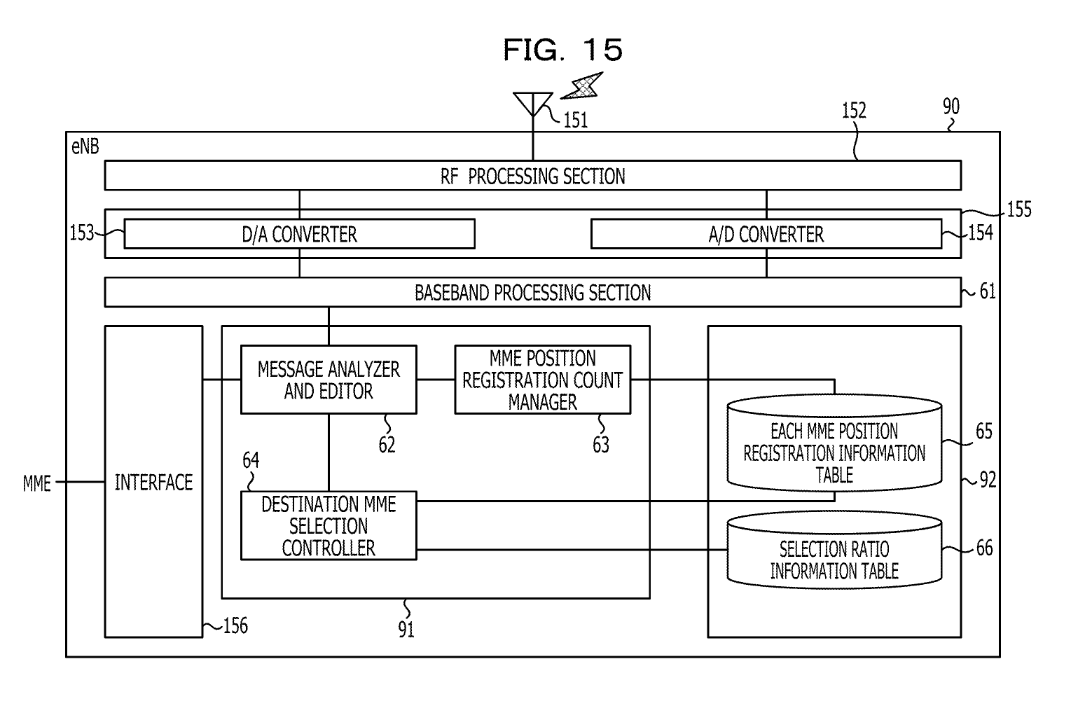

The second embodiment will now be described with reference to FIG. 15 to FIG. 21. A base station, a communication system, and a communication method according to the second embodiment are only specific examples and the second embodiment differs from the first embodiment in that the second embodiment does not include the buffer 67. The entire area to which the second embodiment is applied, the diagram illustrating the hardware configuration and the functional block diagram of the MME, the own MME position registration information table, the each MME position registration information table, the selection ratio information table, and the sequence chart illustrating the process of calculating the selection ratio are the same as the ones illustrated in FIG. 2 to FIG. 4, FIG. 6, FIG. 7, and FIG. 13. The same reference numerals are used in the second embodiment to identify the same components as in the first embodiment. A description of such components is omitted herein.

In the second embodiment, upon notification of the first position registration request from the UE 30, the destination MME selection controller 64 in an eNB 90 inquires of the MMEs 11 to in establishing the S1 interface about the position registration information indicating the position registration counts in the respective MMEs. Then, the destination MME selection controller 64 calculates the selection ratio in the selection of the MME to be notified of the position registration request received from the UE 30 based on the position registration information returned from each MME and notifies the selected MME of the position registration request based on the result of the calculation to perform the position registration. The destination MME selection controller 64 performs the position registration to the position registration requests that are subsequently received for a given time, among the position registration requests that are subsequently received, by using the selection ratio calculated when the position registration request is received from the UE 30.

FIG. 15 is a diagram illustrating an example of a hardware configuration and a functional block diagram of the eNB in the second embodiment.

Referring to FIG. 15, the eNB 90 includes the antenna 151, the RF processing section 152, the conversion processing section 155, the interface 156, the baseband processing section 61, a CPU 91, and a memory 92.

The conversion processing section 155 includes the DA converter 153 and the AD converter 154. The CPU 91 includes the message analyzer and editor 62, the MME position registration count manager 63, and the destination MME selection controller 64. The memory 92 includes the each MME position registration information table 65 and the selection ratio information table 66.

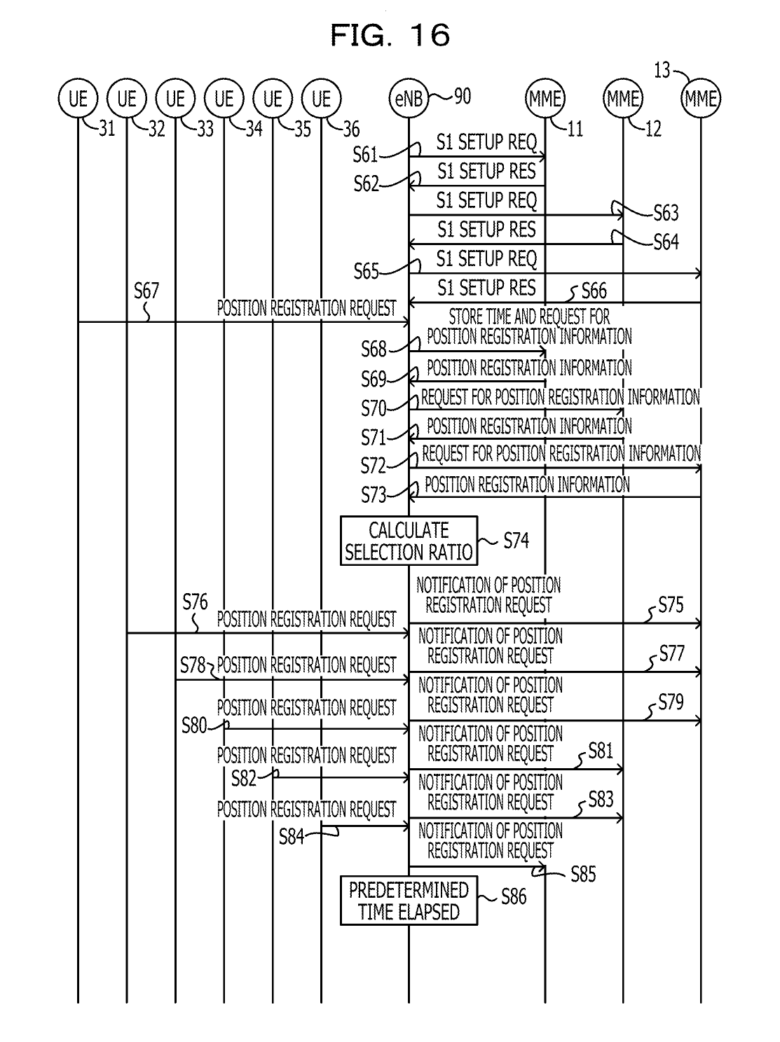

FIG. 16 is a sequence chart in the second embodiment.

Referring to FIG. 16, in S61, the eNB 90 transmits an S1 interface establishment request (S1 SETUP REQ) to the MME 11.

In S62, the MME 11 returns an S1 interface establishment response (S1 SETUP RES) to the eNB 90 upon reception of the S1 interface establishment request (S1 SETUP REQ) from the eNB 90 to establish an S1 interface.

In S63, the eNB 90 transmits the S1 interface establishment request (S1 SETUP REQ) to the MME 12.

In S64, the MME 12 returns the S1 interface establishment response (S1 SETUP RES) to the eNB 90 upon reception of the S1 interface establishment request (S1 SETUP REQ) from the eNB 90 to establish the S1 interface.

In S65, the eNB 90 transmits the S1 interface establishment request (S1 SETUP REQ) to the MME 13.

In S66, the MME 13 returns the S1 interface establishment response (S1 SETUP RES) to the eNB 90 upon reception of the S1 interface establishment request (S1 SETUP REQ) from the eNB 90 to establish the S1 interface.

As in the first embodiment, the eNB 90 achieves the S1-Flex function through S61 to S66.

In S67, the eNB 90 receives the position registration request from the UE 31. In S68, the eNB 90 stores the time when the position registration request is notified from the UE 31 and inquires of the MME 11 about the position registration information indicating the position registration count.

In S69, the MME 11 notifies the eNB 90 of the position registration information including the maximum allowable position registration count and the current position registration count.

In S70, the eNB 90 inquires of the MME 12 about the position registration information indicating the position registration count.

In S71, the MME 12 notifies the eNB 90 of the position registration information including the maximum allowable position registration count and the current position registration count.

In S72, the eNB 90 inquires of the MME 13 about the position registration information indicating the position registration count.

In S73, the MME 13 notifies the eNB 90 of the position registration information including the maximum allowable position registration count and the current position registration count.

In S74, upon notification of the position registration information indicating the position registration counts from all the MMEs establishing the S1 interface with the eNB 90, the eNB 90 calculates the selection ratio in the selection of the MME to be notified of the position registration request received from the UE 30 based on the position registration information notified from the MMEs.

In S75, the eNB 90 notifies the selected MME of the position registration request received from the UE 31 based on the result of the calculation. For example, if the selection ratio is MME 11:MME 12:MME 13=1:2:3, the eNB 90 notifies the MME 13 of the position registration request received from the UE 31.

The eNB 90 notifies the MMEs of the position registration requests in accordance with the calculated selection ratio for a given time. For example, in S76 to S85, if the UE 32, the UE 33, the UE 34, the UE 35, and the UE 36 sequentially notify the eNB 90 of the position registration requests, the eNB 90 notifies the MME 13 of the position registration requests from the UE 32 and the UE 33, like the position registration request from the UE 31, notifies the MME 12 of the position registration requests from the UE 34 and the UE 35, and notifies the MME 11 of the position registration request from the UE 36.

In S86, the eNB 90 determines that the given time elapsed since the first position registration request (the position registration request from the UE 31) has been submitted.

Upon reception of a new position registration request, the eNB 90 goes back to S67 to repeat the above steps (S67 to S85).

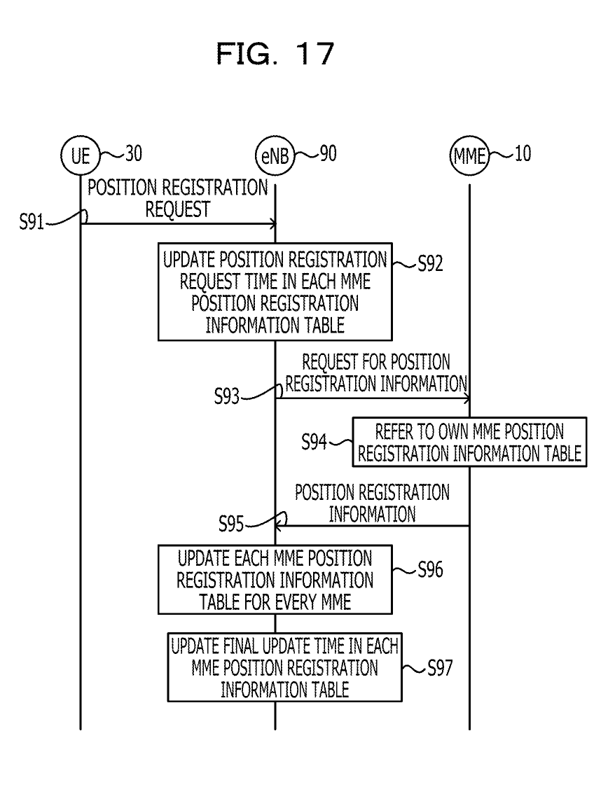

FIG. 17 is a sequence chart illustrating an operational process of acquiring the position registration information in the eNB when the position registration request is submitted in the second embodiment.

Referring to FIG. 17, in S91, the eNB 90 receives a message transmitted from the UE 30 and supplies the message to the message analyzer and editor 62 through the RF processing section 152, the AD converter 154, and the baseband processing section 61. The message analyzer and editor 62 analyzes the supplied message and, if the analysis indicates that the message is the position registration request, supplies the position registration request to the destination MME selection controller 64.

In S92, the destination MME selection controller 64 updates the position registration request time 74 in the each MME position registration information table 65 to the time when the position registration request transmitted from the UE 30 is received.

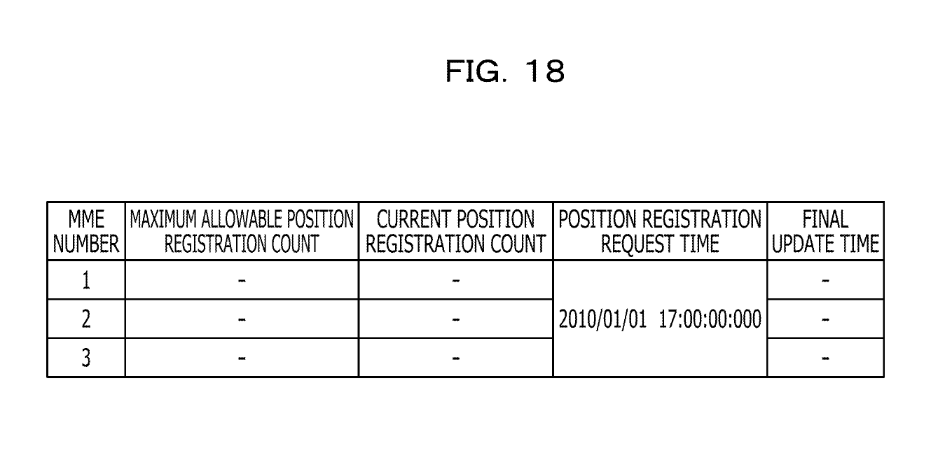

For example, FIG. 18 illustrates an example of the each MME position registration information table 65 when the position registration request is first received in S92. In the example in FIG. 18, the position registration request is notified from the UE 30 at Jan. 1, 2010 17:00:00:000.

The destination MME selection controller 64 indicates to the message analyzer and editor 62 that the position registration request received from the UE 30 is notified.

In S93, the message analyzer and editor 62 edits the message and transmits the request for the position registration information to the MME 10 establishing the S1 interface through the interface 156.

Upon reception of the message transmitted from the eNB 90, the message transmission and reception section 41 in the MME 10 supplies the message to the message analyzer and editor 42. The message analyzer and editor 42 analyzes the supplied message. If the analysis indicates that the supplied message is the request for the position registration information, the message analyzer and editor 42 inquires of the position registration count manager 43 about the position registration information indicating the position registration count in the own MME. In S94, upon reception of the inquiry, the position registration count manager 43 refers to the own MME position registration information table 44. The position registration count manager 43 supplies the current position registration count 51 and the maximum allowable position registration count 52 in the own MME to the message analyzer and editor 42.

In S95, the message analyzer and editor 42 transmits the position registration information including the current position registration count 51 and the maximum allowable position registration count 52 to the eNB 90 through the message transmission and reception section 41.

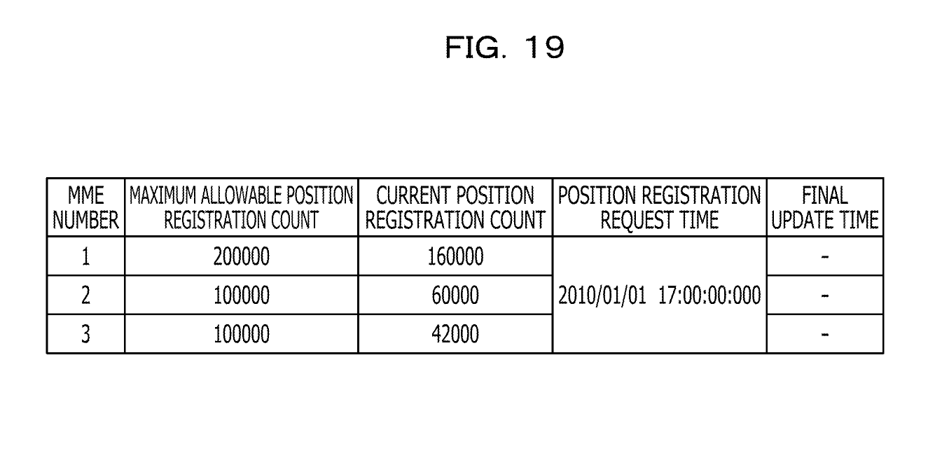

The interface 156 in the eNB 90 supplies the message received from the MME 10 to the message analyzer and editor 62. The message analyzer and editor 62 analyzes the supplied message and, if the message is the position registration information, extracts the current position registration count 51 and the maximum allowable position registration count 52 from the position registration information and supplies the extracted information to the MME position registration count manager 63. In S96, the MME position registration count manager 63 updates the each MME position registration information table 65 for every MME based on the information supplied from the message analyzer and editor 62. FIG. 19 illustrates an example of the each MME position registration information table 65 in S96.

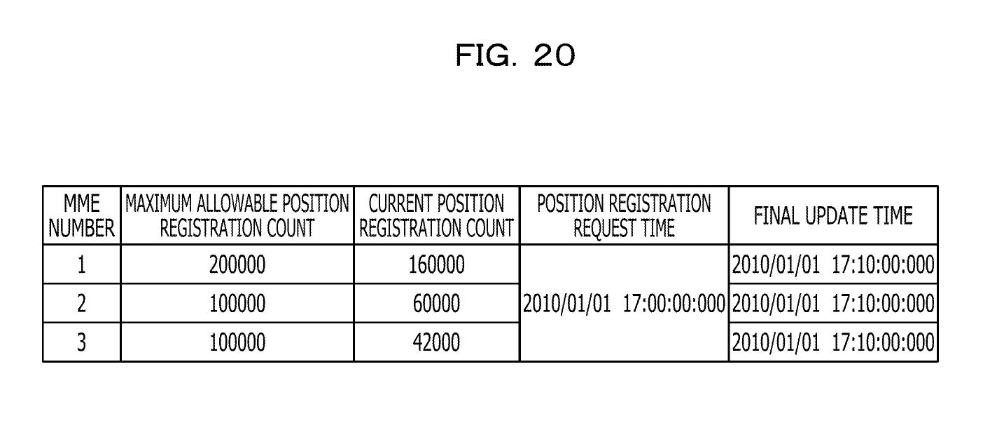

In S97, the MME position registration count manager 63 updates the final update time 75 in the each MME position registration information table 65 to the time when the position registration information is received. FIG. 20 illustrates an example of the each MME position registration information table 65 in S97.

For example, the each MME position registration information table 65 in FIG. 20 indicates that the eNB connected to the MMEs #1, #2, and #3 received the position registration information from each MME at Jan. 1, 2010 17:10:00:000. The MME #1 may register up to 200,000 positions and 160,000 positions are registered in the MME #1 at Jan. 1, 2010 17:00:00:000 in the example in FIG. 20.

S91 in FIG. 17 corresponds to S67 in FIG. 16, S93 in FIG. 17 corresponds to S68, S70, and S72 in FIG. 16, and S95 in FIG. 17 corresponds to S69, S71, and S73 in FIG. 16.

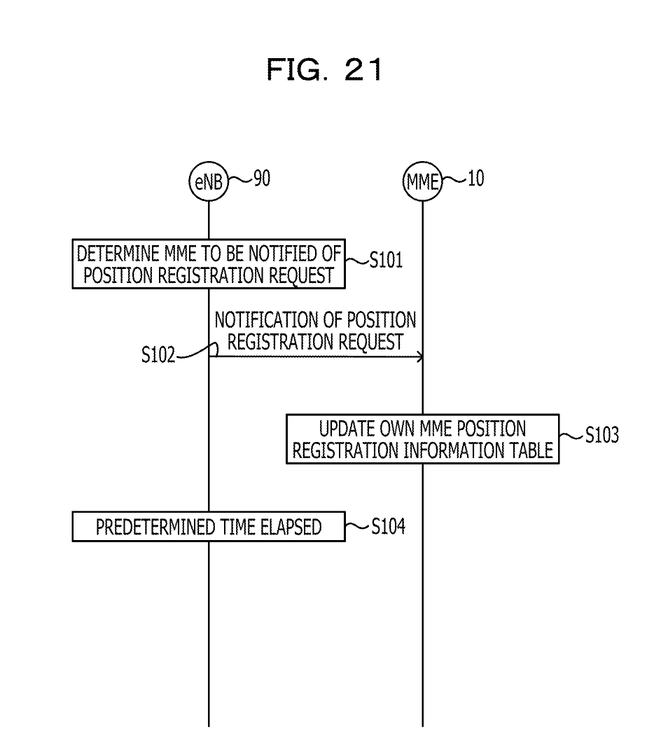

FIG. 21 is a sequence chart illustrating a position registration operation in the eNB in the second embodiment.

Referring to FIG. 21, in S101, the destination MME selection controller 64 determines the MME to be notified of the position registration request received from the UE 30 based on the selection ratio information table 66 and supplies the MME number of the determined MME to be notified of the position registration request to the message analyzer and editor 62.

Upon reception of the MME number of the MME to be notified of the position registration request, the message analyzer and editor 62 edits the message for the MME indicated by the MME number and supplies the message to the interface 156. In S102, the interface 156 transmits the position registration request supplied from the message analyzer and editor 62 to the MME 10 indicated by the MME number.

Upon reception of the message from the eNB 90, the message transmission and reception section 41 in the MME 10 supplies the message to the message analyzer and editor 42. The message analyzer and editor 42 analyzes the message supplied from the message transmission and reception section 41 and, if the message is the position registration request, supplies the position registration request to the position registration count manager 43.

In S103, upon reception of the position registration request from the message analyzer and editor 42, the position registration count manager 43 performs the position registration and updates the current position registration count 51 in the own MME position registration information table 44.

In S104, the destination MME selection controller 64 in the eNB 90 refers to the position registration request time 74 in the each MME position registration information table 65 to compare the position registration request time 74 with the current time and stops the selection of the MME to be notified of the position registration request received from the UE 30 using the current selection ratio information table 66 when a given time elapsed.

S101 in FIG. 21 corresponds to S74 in FIG. 16, S102 in FIG. 21 corresponds to S75, S77, S79, S81, S83, and S85 in FIG. 16, and S104 in FIG. 21 corresponds to S86 in FIG. 16.

According to the second embodiment, even if any eNB exists which performs the position registration to part of MMEs, among the MMEs that have the same position registration area including the multiple eNBs under their control, the eNB of the present embodiment determines the MMEs to be notified of the position registration requests so that the position registration count of the UE is balanced between the respective MMEs to balance the load between the MMEs having the same position registration area under their control.

In addition, the selection of the MMEs to be notified of the position registration requests received from the pieces of UE by using the same selection ratio for a given time allows the number of times when the MME notifies the eNB of the position registration information to be decreased to reduce the load on the MMEs.

Furthermore, the determination of the MME to be notified of the position registration request by using the selection ratio when the notification of the position registration request to the MME is started allows the eNB to notify the MME selected by using the selection ratio of the position registration request immediately after the position registration request is transmitted from the UE. Accordingly, it is possible to quickly perform the position registration.

### Third Embodiment

In a third embodiment, upon start of reception of the position registration requests by each base station, multiple higher-level stations are instructed to transmit the load information, higher-level stations to be notified of the position registration requests of a given number received after the reception of the position registration request is started are selected from the multiple higher-level stations based on the load information received in response to the transmission instruction, and the selected higher-level stations are notified of the position registration requests to realize the load balancing between the multiple higher-level stations.

Although the position registration information indicating the position registration count in each MME is described as an example of the load information in the following description, the load on each MME is not limited to the position registration count.

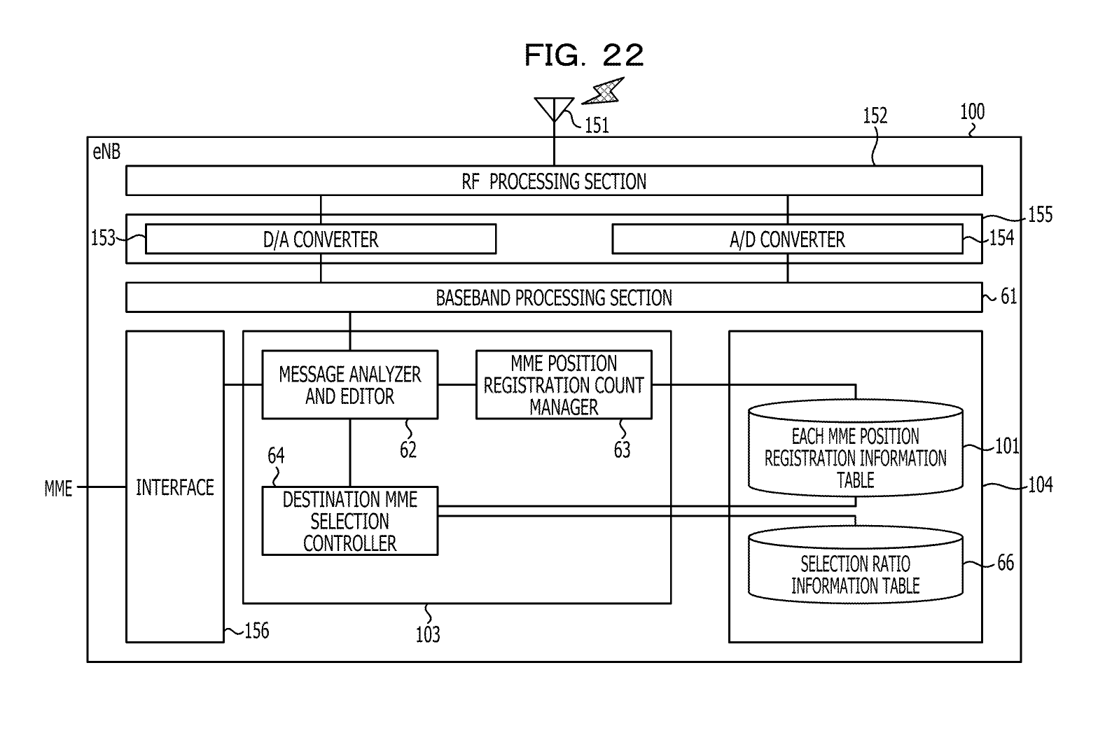

The third embodiment will now be described with reference to FIG. 22 to FIG. 29. A base station, a communication system, and a communication method according to the third embodiment are only specific examples and the third embodiment differs from the second embodiment in the time when the destination MME selection controller stops the use of the current selection ratio information table and the each MME position registration information table. The entire area to which the third embodiment is applied, the diagram illustrating the hardware configuration and the functional block diagram of the MME, the own MME position registration information table, the selection ratio information table, and the sequence chart illustrating the process of calculating the selection ratio are the same as the ones illustrated in FIG. 2, FIG. 3, FIG. 4, FIG. 7, and FIG. 13. The same reference numerals are used in the third embodiment to identify the same components as in the second embodiment. A description of such components is omitted herein.

In the third embodiment, upon reception of the position registration request from the UE 31, the destination MME selection controller 64 in an eNB 100 inquires of the MMEs 11 to in establishing the S1 interface about the position registration information indicating the position registration counts in the respective MMEs. Then, the destination MME selection controller 64 calculates the selection ratio in the selection of the MME to be notified of the position registration request received from the UE 31 based on the position registration information returned from each MME and notifies the selected MME of the position registration request based on the result of the calculation. The destination MME selection controller 64 selects the MMEs to be notified of the position registration requests that are subsequently received from the pieces of UE by using the calculated selection ratio. The destination MME selection controller 64 stops the selection of the MME to be notified of the position registration request by using the current selection ratio when the selected MMEs are notified of the position registration requests of a given number.

FIG. 22 is a diagram illustrating an example of a hardware configuration and a functional block diagram of the eNB in the third embodiment.

Referring to FIG. 22, the eNB 100 includes the antenna 151, the RF processing section 152, the conversion processing section 155, the interface 156, the baseband processing section 61, a CPU 103, and a memory 104.

The conversion processing section 155 includes the DA converter 153 and the AD converter 154. The CPU 103 includes the message analyzer and editor 62, the MME position registration count manager 63, and the destination MME selection controller 64. The memory 104 includes an each MME position registration information table 101 and the selection ratio information table 66.

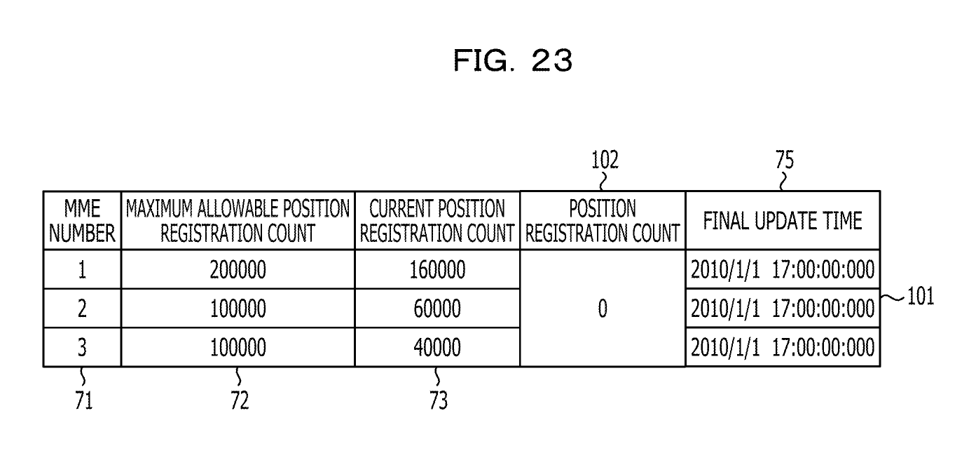

FIG. 23 illustrates an example of the each MME position registration information table in the third embodiment.

In the example in FIG. 23, the MME number 71, the maximum allowable position registration count 72, the current position registration count 73, a position registration count 102, and the final update time 75 are stored in the each MME position registration information table 101 in association with each other.

The position registration count 102 indicates the number of times when the eNB uses the selection ratio information table 66 to select the MME to be notified of the position registration request and notifies the selected MME of the position registration request.

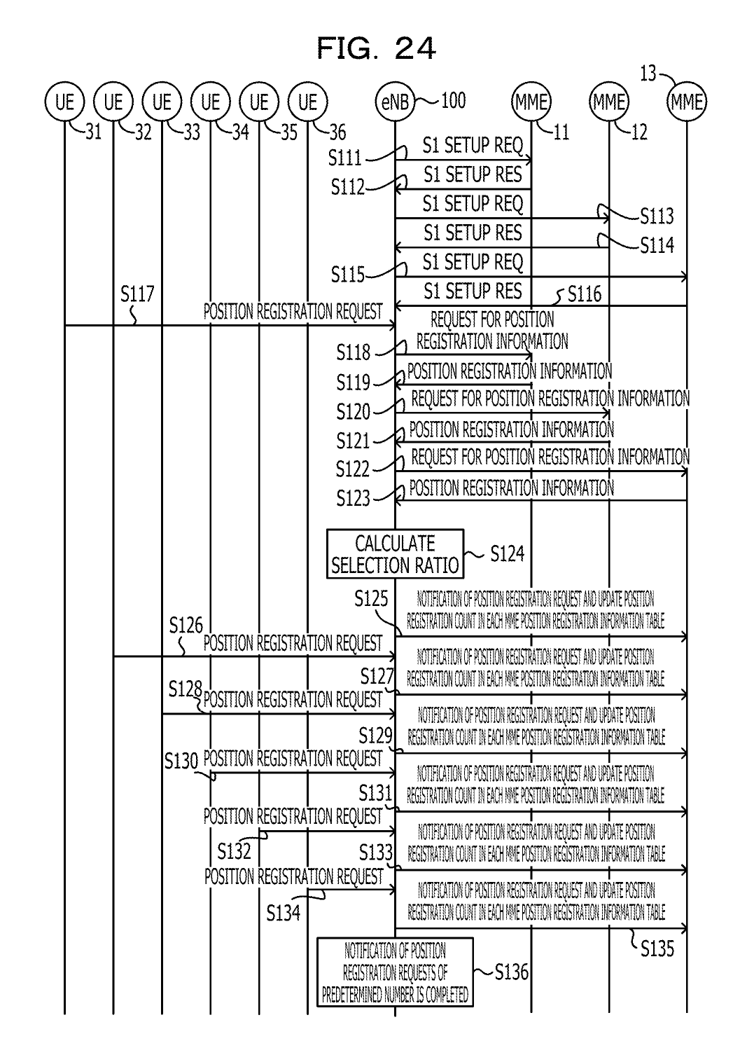

FIG. 24 is a sequence chart in the third embodiment.

Referring to FIG. 24, in S111, the eNB 100 transmits an S1 interface establishment request (S1 SETUP REQ) to the MME 11.

In S112, the MME 11 returns an S1 interface establishment response (S1 SETUP RES) to the eNB 100 upon reception of the S1 interface establishment request (S1 SETUP REQ) from the eNB 100 to establish an S1 interface.

In S113, the eNB 100 transmits the S1 interface establishment request (S1 SETUP REQ) to the MME 12.

In S114, the MME 12 returns the S1 interface establishment response (S1 SETUP RES) to the eNB 100 upon reception of the S1 interface establishment request (S1 SETUP REQ) from the eNB 100 to establish the S1 interface.

In S115, the eNB 100 transmits the S1 interface establishment request (S1 SETUP REQ) to the MME 13.

In S116, the MME 13 returns the S1 interface establishment response (S1 SETUP RES) to the eNB 100 upon reception of the S1 interface establishment request (S1 SETUP REQ) from the eNB 100 to establish the S1 interface.

As in the first and second embodiments, the eNB 100 achieves the S1-Flex function through S111 to S116.

In S117, the eNB 100 receives the position registration request from the UE 31. In S118, the eNB 100 inquires of the MME 11 about the position registration information indicating the position registration count.

In S119, the MME 11 notifies the eNB 100 of the position registration information including the maximum allowable position registration count and the current position registration count.

In S120, the eNB 100 inquires of the MME 12 about the position registration information indicating the position registration count.

In S121, the MME 12 notifies the eNB 100 of the position registration information including the maximum allowable position registration count and the current position registration count.

In S122, the eNB 100 inquires of the MME 13 about the position registration information indicating the position registration count.

In S123, the MME 13 notifies the eNB 100 of the position registration information including the maximum allowable position registration count and the current position registration count.

In S124, upon notification of the position registration information indicating the position registration counts from all the MMEs establishing the S1 interface with the eNB 100, the eNB 100 calculates the selection ratio in the selection of the MME to be notified of the position registration request received from the UE based on the position registration information notified from the MMEs.

In S125, the eNB 100 notifies the selected MME of the position registration request received from the UE 31 based on the result of the calculation and updates the position registration count 102 in the each MME position registration information table 101. For example, if the selection ratio is MME 11:MME 12:MME 13=1:2:3, the eNB 100 notifies the MME 13 of the position registration request and increments the position registration count 102 in the each MME position registration information table 101.

The eNB 100 notifies the selected MME of the position registration request received from the UE in accordance with the selection ratio calculated in S124 and updates the position registration count 102 in the each MME position registration information table 101 until the position registration is performed a given number of times. For example, in S126 to S135, if the eNB 100 selects the MMEs to be notified of the six position registration requests by using the current selection ratio and the UE 32, the UE 33, the UE 34, the UE 35, and the UE 36 sequentially notify the eNB 100 of the position registration requests, the eNB 100 notifies the MME 13 of the position registration requests from the UE 32 and the UE 33, like the position registration request from the UE 31, to increment the position registration count 102 in the each MME position registration information table 101, notifies the MME 12 of the position registration requests from the UE 34 and the UE 35 to increment the position registration count 102 in the each MME position registration information table 101, and notifies the MME 11 of the position registration request from the UE 36 to increment the position registration count 102 in the each MME position registration information table 101.

In S136, the eNB 100 notifies the selected MMEs of the first position registration request (the position registration request from the UE 31) and the subsequent position registration requests and determines that the notification of the position registration requests of the given number is completed.

Upon reception of a new position registration request transmitted from the UE, the eNB 100 goes back to S117 to repeat the above steps.

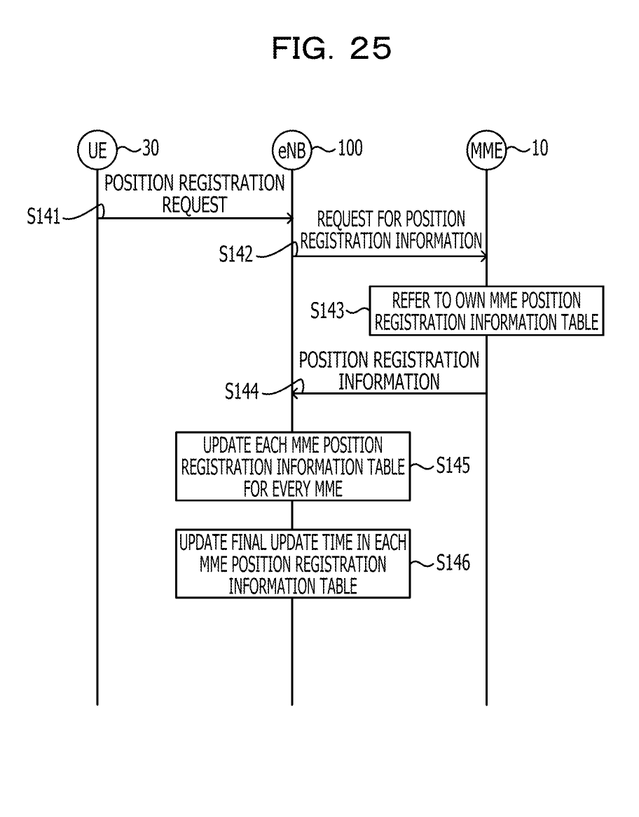

FIG. 25 is a sequence chart illustrating an operational process of acquiring the position registration information in the eNB when the position registration request is submitted in the third embodiment.

Referring to FIG. 25, in S141, the eNB 100 receives a message transmitted from the UE 30 and supplies the message to the message analyzer and editor 62 through the RF processing section 152, the AD converter 154, and the baseband processing section 61. The message analyzer and editor 62 analyzes the supplied message and, if the analysis indicates that the message is the position registration request, supplies the position registration request to the destination MME selection controller 64.

The destination MME selection controller 64 indicates to the message analyzer and editor 62 that the position registration request is notified.

In S142, the message analyzer and editor 62 edits the message and transmits the request for the position registration information to the respective MMEs establishing the S1 interface through the interface 156.

Upon reception of the message transmitted from the eNB 100, the message transmission and reception section 41 in the MME 10 supplies the message to the message analyzer and editor 42. The message analyzer and editor 42 analyzes the supplied message. If the analysis indicates that the supplied message is the request for the position registration information, the message analyzer and editor 42 inquires of the position registration count manager 43 about the position registration information indicating the position registration count in the own MME. In S143, upon reception of the inquiry, the position registration count manager 43 refers to the own MME position registration information table 44. The position registration count manager 43 supplies the current position registration count 51 and the maximum allowable position registration count 52 in the own MME to the message analyzer and editor 42.

In S144, the message analyzer and editor 42 transmits the position registration information including the current position registration count 51 and the maximum allowable position registration count 52 to the eNB 100 through the message transmission and reception section 41.

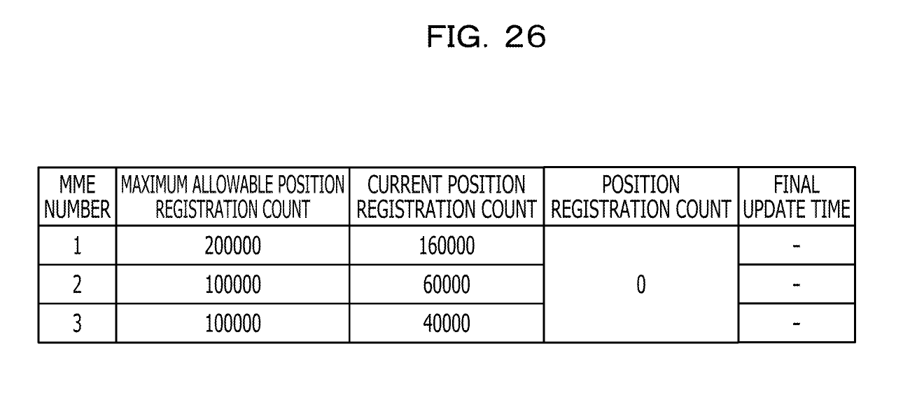

The interface 156 in the eNB 100 supplies the message received from the MME 10 to the message analyzer and editor 62. The message analyzer and editor 62 analyzes the supplied message and, if the message is the position registration information indicating the position registration count, extracts the current position registration count 51 and the maximum allowable position registration count 52 from the position registration information and supplies the extracted information to the MME position registration count manager 63. In S145, the MME position registration count manager 63 updates the each MME position registration information table 101 for every MME based on the information supplied from the message analyzer and editor 62. FIG. 26 illustrates an example of the each MME position registration information table 101 in S145.

In S146, the MME position registration count manager 63 updates the final update time 75 in the each MME position registration information table 101 to the time when the position registration information indicating the position registration count is received from each MME.

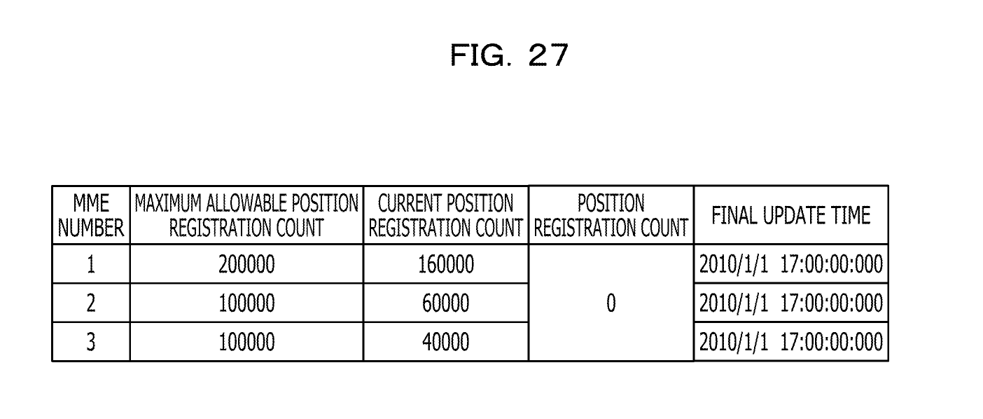

FIG. 27 illustrates an example of the each MME position registration information table 101 in S146.

S141 in FIG. 25 corresponds to S117 in FIG. 24, S142 in FIG. 25 corresponds to S118, S120, and S122 in FIG. 24, and S144 in FIG. 25 corresponds to S119, S121, and S123 in FIG. 24.

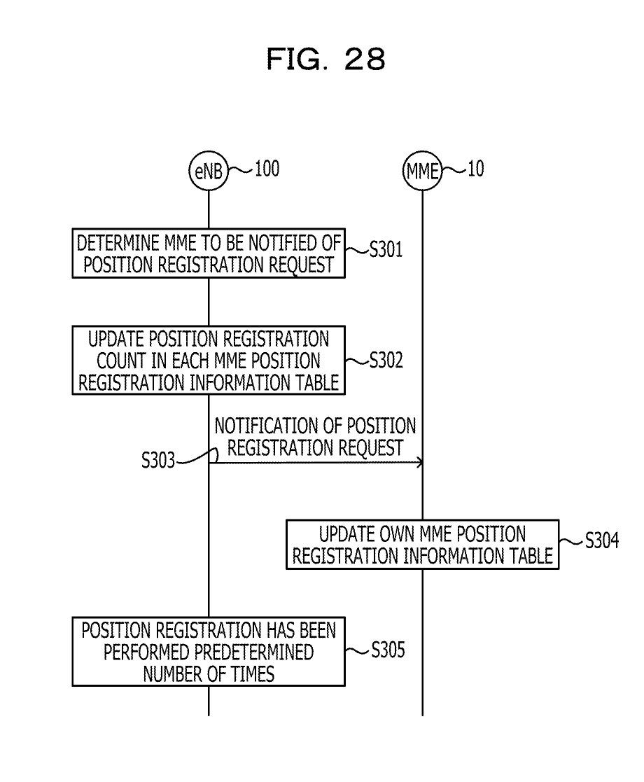

FIG. 28 is a sequence chart illustrating a position registration operation in the eNB in the third embodiment.

Referring to FIG. 28, in S241, the destination MME selection controller 64 determines the MME to be notified of the position registration request received from the UE based on the selection ratio information table 66 and supplies the MME number of the determined MME to be notified of the position registration request to the message analyzer and editor 62.

In S242, the destination MME selection controller 64 updates the position registration count 102 in the each MME position registration information table 101.

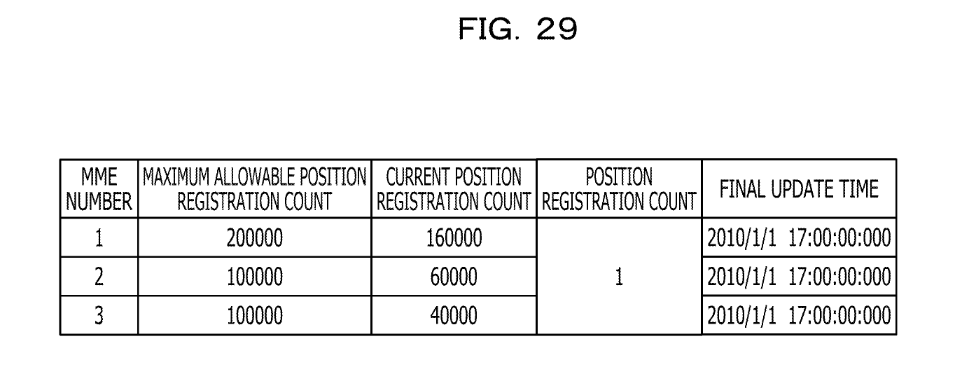

FIG. 29 illustrates an example of the each MME position registration information table 101 in S242.

Upon reception of the MME number of the MME to be notified of the position registration request, the message analyzer and editor 62 edits the message for the MME indicated by the MME number and supplies the message to the interface 156 as the position registration request. In S243, the interface 156 transmits the supplied position registration request to the MME 10 indicated by the MME number.

Upon reception of the message from the eNB 100, the message transmission and reception section 41 in the MME 10 supplies the message to the message analyzer and editor 42. The message analyzer and editor 42 analyzes the message and, if the message is the position registration request, supplies the position registration request to the position registration count manager 43.

In S244, upon reception of the position registration request, the position registration count manager 43 performs the position registration and updates the own MME position registration information table 44.

In S245, the destination MME selection controller 64 in the eNB 100 refers to the position registration count 102 in the each MME position registration information table 101 to stop the selection of the MME 10 to be notified of the position registration request by using the current selection ratio information table 66 when the value of the position registration count 102 reaches a given number, which indicates that the position registration has been performed the given number of times.

S241 in FIG. 28 corresponds to S124 in FIG. 24, S243 in FIG. 28 corresponds to S125, S127, S129, S131, S133, and S135 in FIG. 24, S245 in FIG. 28 corresponds to S136 in FIG. 24.

According to the third embodiment, even if any eNB exists which performs the position registration to part of MMEs, among the MMEs that have the same position registration area including the multiple eNBs under their control, the eNB of the present embodiment selects the MMEs to be notified of the position registration requests from the pieces of UE so that the position registration counts are balanced between the MMEs having the same position registration area under their control to balance the load between the MMEs having the same position registration area under their control.

In addition, the MMEs may be notified of the position registration requests of a given number by using the same selection ratio to decrease the number of times when the MME notifies the eNB of the position registration information, thereby reducing the load on the MMEs.

Furthermore, the selection of the MMEs to be notified of the subsequent position registration requests by using the selection ratio when the notification of the position registration request is started allows the eNB to select the MME to be notified of the position registration request by using the selection ratio immediately after the position registration request is transmitted from the UE. Accordingly, it is possible to quickly perform the position registration.

### Fourth Embodiment

In a fourth embodiment, multiple higher-level stations each receive statistical information indicating the statistical value of the load of the processing on each higher-level station and, if the higher-level station determines that the load information is not reliable when a given time elapsed since the reception of the load information, selects higher-level stations that are position registration destinations by using the statistical information to realize the load balancing between the multiple higher-level stations.

Although each MME, each eNB, and each piece of UE are described as examples of the higher-level station, the base station, and the mobile station, respectively, the position registration information indicating the position registration count in each MME is described as an example of the load information, and information indicating the statistical value of the position registration count summed up in each MME is described as an example of the statistical information in the following description, the processing load on each MME is not limited to the position registration count.

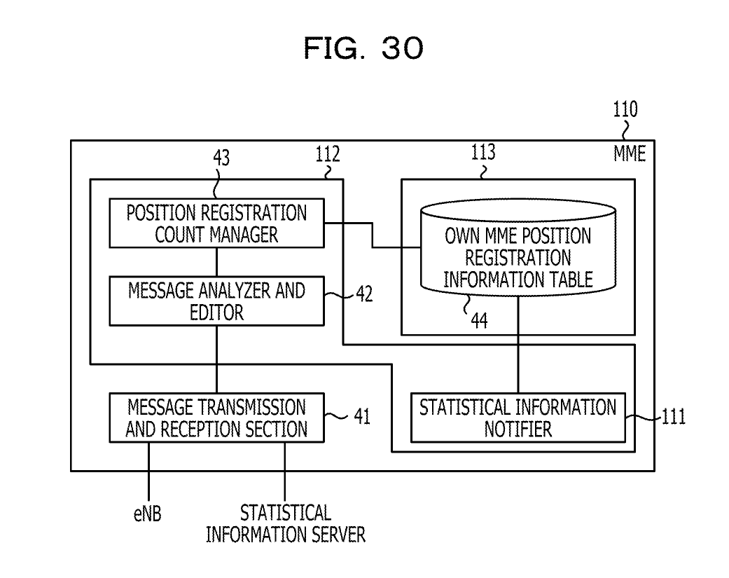

The fourth embodiment will now be described with reference to FIG. 30 to FIG. 46. A base station, a communication system, and a communication method according to the fourth embodiment are only specific examples and the fourth embodiment differs from the third embodiment in that the fourth embodiment includes a statistical information server. The entire area to which the fourth embodiment is applied, the own MME position registration information table, and the selection ratio information table are the same as the ones illustrated in FIG. 2, FIG. 4, and FIG. 7. The same reference numerals are used in the fourth embodiment to identify the same components as in the third embodiment. A description of such components is omitted herein.

In the fourth embodiment, upon notification of the position registration request from the UE 31, the destination MME selection controller 64 in an eNB 120 inquires of the MMEs 11 to in establishing the S1 interface about the position registration information indicating the position registration count. Then, the destination MME selection controller 64 calculates the selection ratio in the selection of the MME to be notified of the position registration request received from the UE based on the position registration information returned from each MME and notifies the MMEs of the position registration requests of a given number based on the result of the calculation. For example, when the second position registration request is received after at least a given time elapsed since the first position registration request was received from the UE, the destination MME selection controller 64 uses the statistical information indicating the statistical value of the position registration count summed up in each MME to select the MME to be notified of the position registration request.

FIG. 30 is a diagram illustrating an example of a hardware configuration and a functional block diagram of a MME in the fourth embodiment.

Referring to FIG. 30, an MME 110 includes the message transmission and reception section 41, the message analyzer and editor 42, the position registration count manager 43, a statistical information notifier 111, and the own MME position registration information table 44. The message transmission and reception section 41, the message analyzer and editor 42, the position registration count manager 43, and the statistical information notifier 111 are included in a CPU 112, and the own MME position registration information table 44 is included in a memory 113.

The statistical information notifier 111, for example, periodically notifies a statistical information server 130 described below of information included in the own MME position registration information table 44.

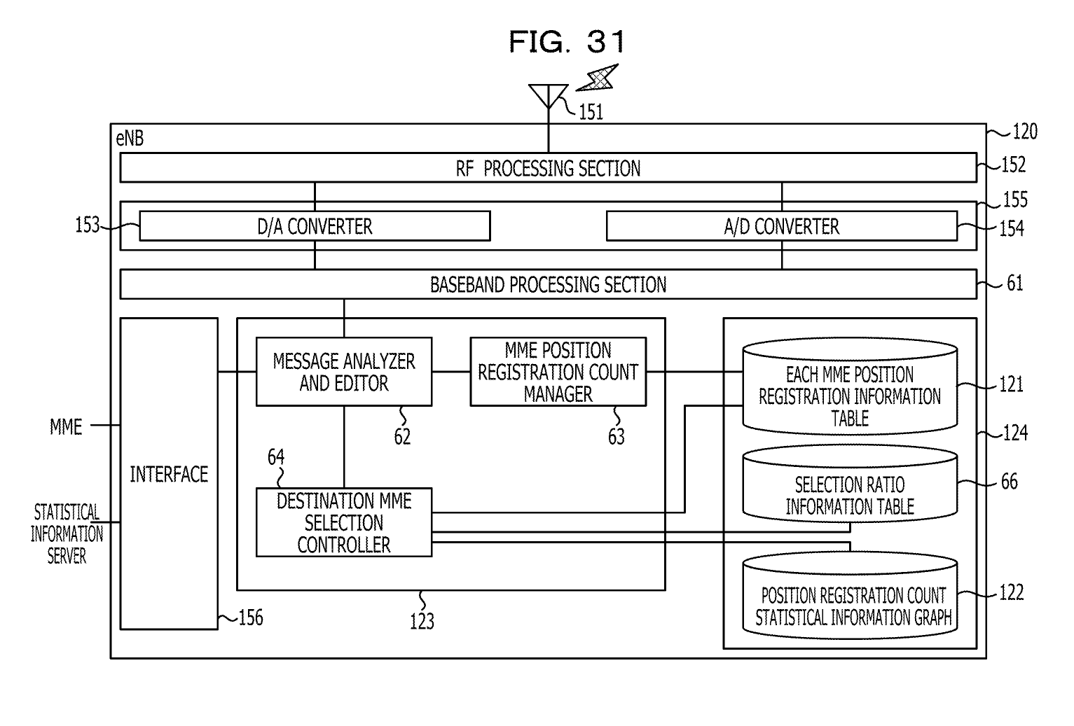

FIG. 31 is a diagram illustrating an example of a hardware configuration and a functional block diagram of the eNB in the fourth embodiment.

Referring to FIG. 31, the eNB 120 includes the antenna 151, the RF processing section 152, the conversion processing section 155 including the DA converter 153 and the AD converter 154, the interface 156, the baseband processing section 61, the message analyzer and editor 62, the MME position registration count manager 63, the destination MME selection controller 64, an each MME position registration information table 121, the selection ratio information table 66, and a position registration count statistical information graph 122. The message analyzer and editor 62, the MME position registration count manager 63, and the destination MME selection controller 64 are included in a CPU 123. The each MME position registration information table 121, the selection ratio information table 66, and the position registration count statistical information graph 122 are included in a memory 124.

The current position registration count, the maximum allowable position registration count, etc. of each MME are recorded in the each MME position registration information table 121.

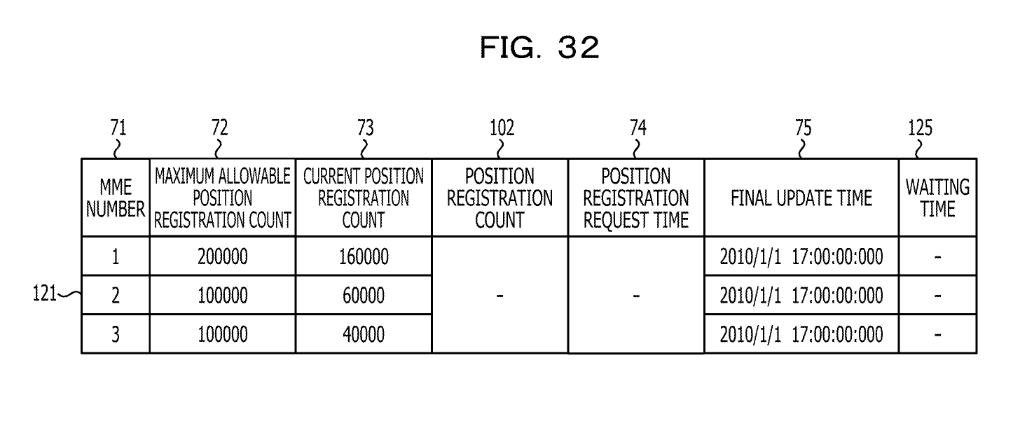

FIG. 32 illustrates an example of the each MME position registration information table 121. In the example in FIG. 32, the MME number 71, the maximum allowable position registration count 72, the current position registration count 73, the position registration request time 74, the final update time 75, the position registration count 102, and a waiting time 125 are stored in the each MME position registration information table 121 in association with each other. The waiting time 125 indicates, for example, a time limit when the MME 11 is excluded from candidates for the MME to be notified of the position registration request based on the position registration count statistical information graph 122 described below.

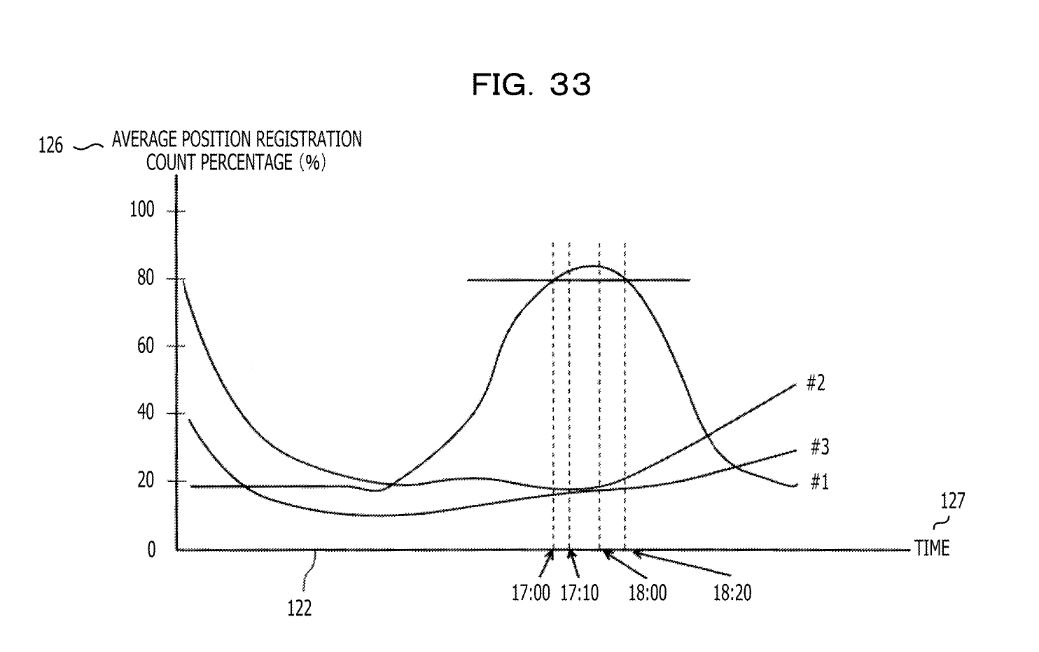

Statistical information indicating the position registration count at each time in one day in each MME, notified from the statistical information server 130, is stored in the position registration count statistical information graph 122. FIG. 33 illustrates an example of the position registration count statistical information graph 122. In the position registration count statistical information graph 122 in FIG. 33, an average position registration count percentage 126 indicating the percentage of the average position registration count to the maximum allowable position registration count in the MME is represented as the vertical axis and time 127 is represented as the horizontal axis. The position registration count statistical information graph 122 illustrates the average position registration count percentage 126 at each time in one day in each MME. Although the average position registration count percentage is represented as the vertical axis, the current position registration count may be represented as the vertical axis.

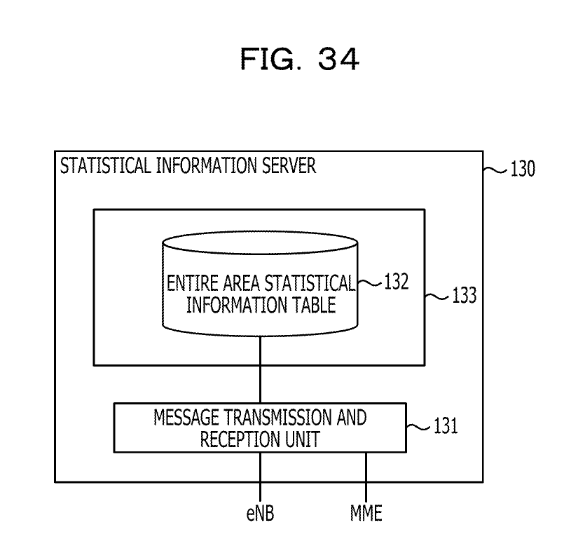

FIG. 34 is a diagram illustrating an example of a hardware configuration and a functional block diagram of the statistical information server in the fourth embodiment.

Referring to FIG. 34, the statistical information server 130 includes a message transmission and reception section 131 and an entire area statistical information table 132. The entire area statistical information table 132 is included in a memory 133.

The message transmission and reception section 131 transmits statistical information in one day, which is the statistical information indicating the position registration count in each MME summed up at each time, to the eNB 120 based on the entire area statistical information table 132 and periodically receives information indicating the position registration count in the MME 110 from the MME 110.

The entire area statistical information table 132 holds the statistical information indicating the position registration count for every MME based on the information indicating the position registration count, periodically transmitted from the MME 110.

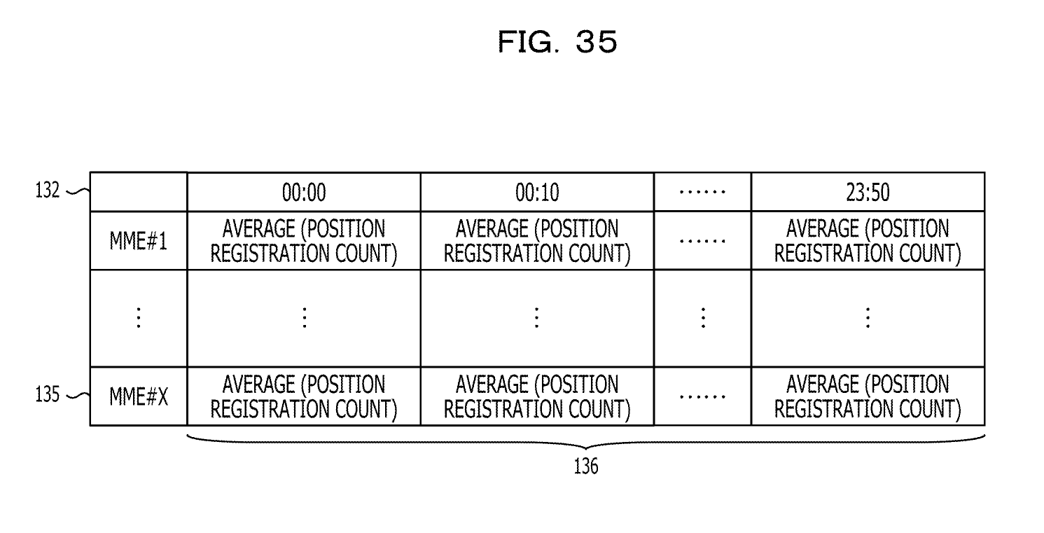

FIG. 35 illustrates an example of the entire area statistical information table 132. In the example in FIG. 35, an MME number 135 and an average position registration count at each time 136 are stored in the entire area statistical information table 132 in association with each other. The MME number 135 indicates a number with which each MME is identified. The average position registration count at each time 136 indicates an average position registration count at a certain time for every MME.

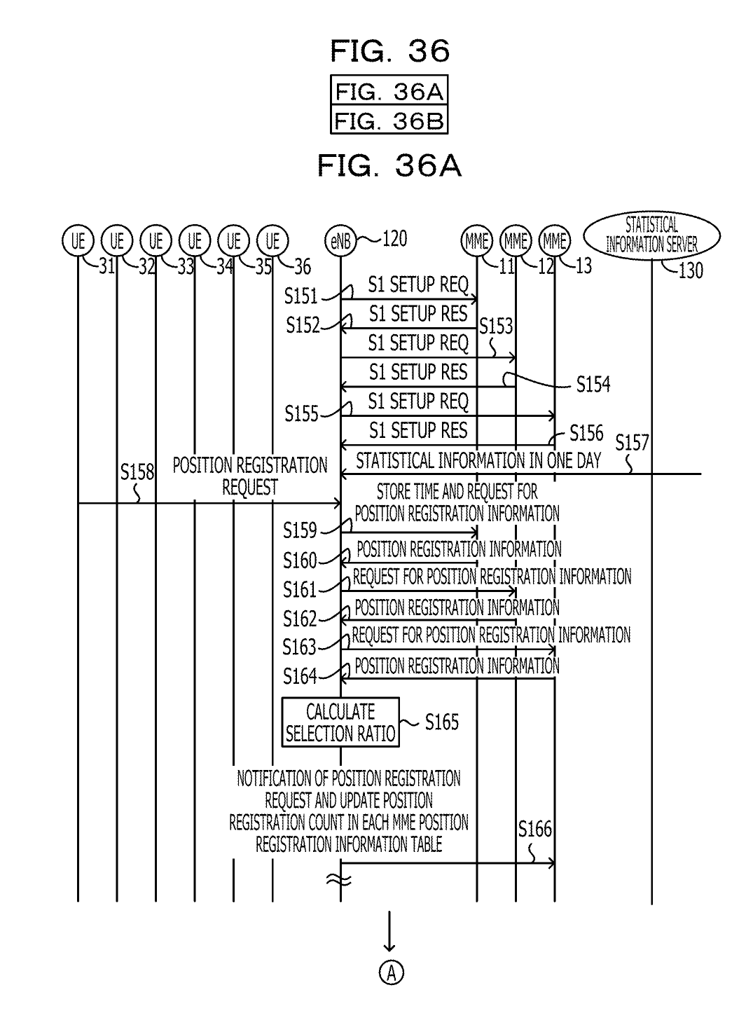

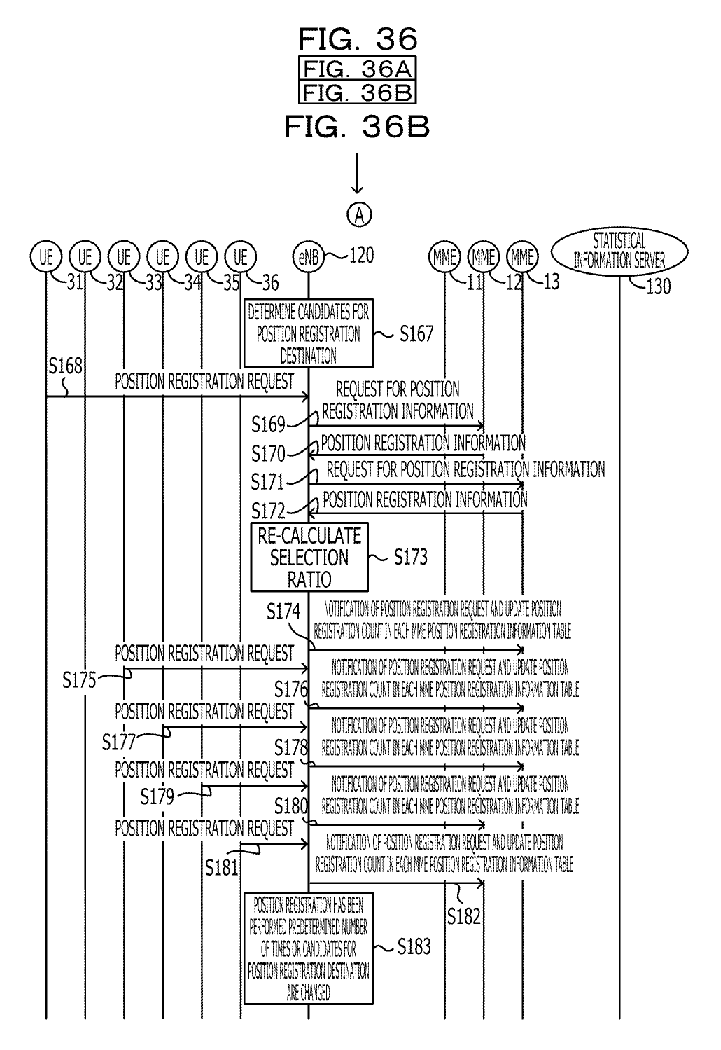

FIG. 36 is a sequence chart in the fourth embodiment.

Referring to FIG. 36, in S151, the eNB 120 transmits an S1 interface establishment request (S1 SETUP REQ) to the MME 11.

In S152, the MME 11 returns an S1 interface establishment response (S1 SETUP RES) to the eNB 120 upon reception of the S1 interface establishment request (S1 SETUP REQ) from the eNB 120 to establish an S1 interface.

In S153, the eNB 120 transmits the S1 interface establishment request (S1 SETUP REQ) to the MME 12.

In S154, the MME 12 returns the S1 interface establishment response (S1 SETUP RES) to the eNB 120 upon reception of the S1 interface establishment request (S1 SETUP REQ) from the eNB 120 to establish the S1 interface.

In S155, the eNB 120 transmits the S1 interface establishment request (S1 SETUP REQ) to the MME 13.

In S156, the MME 13 returns the S1 interface establishment response (S1 SETUP RES) to the eNB 120 upon reception of the S1 interface establishment request (S1 SETUP REQ) from the eNB 120 to establish the S1 interface. As in the first to third embodiments, the eNB 120 achieves the S1-Flex function through S151 to S156.

In S157, the statistical information server 130 transmits the statistical information in one day in the MME establishing the S1 interface with the eNB 120 periodically (for example, every day).

In S158, the eNB 120 receives the position registration request from the UE 31. In S159, the eNB 120 stores the time when the position registration request is received from the UE 31 and inquires of the MME 11 about the position registration information indicating the position registration count.

In S160, the MME 11 notifies the eNB 120 of the position registration information including the maximum allowable position registration count and the current position registration count.

In S161, the eNB 120 inquires of the MME 12 about the position registration information indicating the position registration count.

In S162, the MME 12 notifies the eNB 120 of the position registration information including the maximum allowable position registration count and the current position registration count.

In S163, the eNB 120 inquires of the MME 13 about the position registration information indicating the position registration count.

In S164, the MME 13 notifies the eNB 120 of the position registration information including the maximum allowable position registration count and the current position registration count.

In S165, upon notification of the position registration information indicating the position registration counts from all the MMEs establishing the S1 interface with the eNB 120, the eNB 120 calculates the selection ratio in the selection of the MME to be notified of the position registration request received from the UE based on the position registration information notified from the MMEs.

In S166, the eNB 120 notifies the selected MME of the position registration request received from the UE 31 based on the result of the calculation and updates the position registration count 102 in the each MME position registration information table 121. For example, if the selection ratio is MME 11:MME 12:MME 13=1:2:3, the eNB 120 notifies the MME 13 of the position registration request and increments the position registration count 102 in the each MME position registration information table 121.

In S167, for example, the eNB 120 compares the time when the position registration request is received, stored in S159, (the time when the position registration request is received from the UE 31) with the current time and, if no position registration request is received from the UE 30 for at least a given time, refers to the position registration count statistical information graph 122 to compare the average position registration count percentage in the position registration count statistical information graph 122 at the current time in each MME with the current position registration count percentage in each MME. The MME whose average position registration count percentage in the position registration count statistical information graph 122 at the current time is higher than the current position registration count percentage is excluded from the candidates for the position registration destination before the position registration count in the position registration count statistical information graph 122 becomes lower than the position registration count in the MME.

In S168, the eNB 120 receives the position registration request from the UE 32. The eNB 120 re-calculates the selection ratio in the selection of the MME other than the MME excluded in S167, which is to be notified of the position registration request.

In S169, the eNB 120 inquires of the MME 12 about the position registration information indicating the position registration count in order to re-calculate the selection ratio.

In S170, the MME 12 notifies the eNB 120 of the position registration information including the maximum allowable position registration count and the current position registration count.

In S171, the eNB 120 inquires of the MME 13 about the position registration information indicating the position registration count.

In S172, the MME 13 notifies the eNB 120 of the position registration information including the maximum allowable position registration count and the current position registration count.

In S173, upon notification of the position registration information indicating the position registration counts from all the MMEs other than the MME excluded in S167, which establish the S1 interface with the eNB 120, the eNB 120 re-calculates the selection ratio in the selection of the MME to be notified of the position registration request based on the position registration information notified from the MMEs. For example, it is assumed that the MME 11 is excluded from the MMEs to be notified of the position registration requests and the selection ratio is MME 12:MME 13=2:3.

In S174, the eNB 120 notifies the MME 13 of the position registration request in accordance with the re-calculated selection ratio and updates the position registration count 102 in the each MME position registration information table 121. For example, in S175 to S182, if the selection ratio is updated for every position registration requests corresponding to five calls and the UE 33, the UE 34, the UE 35, and the UE 36 sequentially notify the eNB 120 of the position registration requests, the eNB 120 notifies the MME 13 of the position registration requests received from the UE 33 and the UE 34 to increment the position registration count 102 in the each MME position registration information table 121 and notifies the MME 12 of the position registration requests received from the UE 35 and the UE 36 to increment the position registration count 102 in the each MME position registration information table 121.

In S183, the eNB 120 determines that the eNB 120 has notified the selected MMEs of the first position registration request after the re-calculation (the position registration request from the UE 33) and the subsequent position registration requests of a given number or that, for each MME whose average position registration count percentage in the position registration count statistical information graph 122 at the current time is higher than the position registration count percentage, the average position registration count percentage in the position registration count statistical information graph 122 becomes lower than the position registration count percentage in the MME.

Upon reception of a new position registration request from the UE, the eNB 120 goes back to S168 or S158 to repeat the above steps.

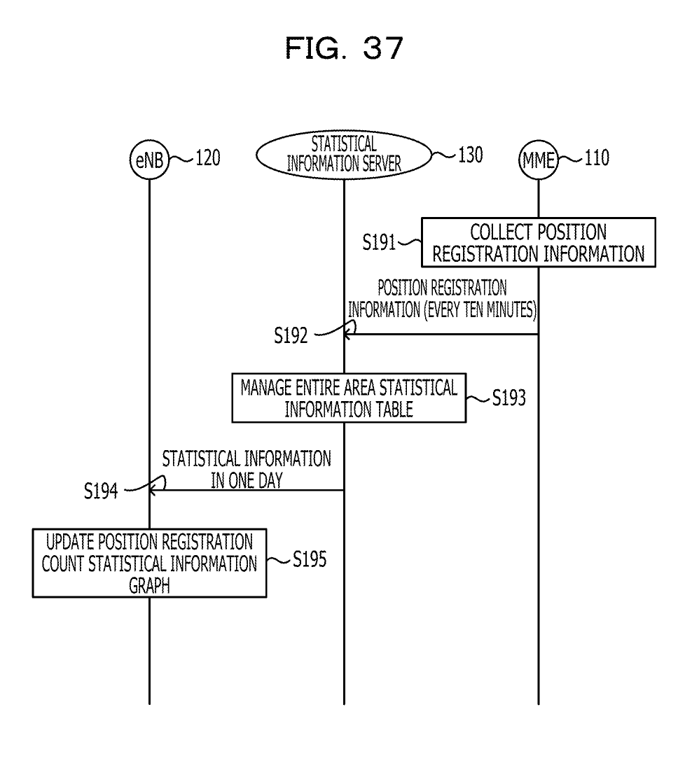

FIG. 37 is a sequence chart illustrating a process of updating the position registration count statistical information graph 122 in the fourth embodiment.

Referring to FIG. 37, in S191, the statistical information notifier 111 in the MME 110 collects the position registration information indicating the position registration count periodically (for example, every ten minutes) based on the own MME position registration information table 44. In S192, the statistical information notifier 111 notifies the statistical information server 130 of the position registration information.

In S193, the statistical information server 130 sums up the position registration information notified from the MME with the message transmission and reception section 131 and manages the position registration information as the statistical information for every MME with the entire area statistical information table 132. For example, in the management, the pieces of position registration information are averaged for every section time (for example, every ten minutes) every day and the averages are held.

In S194, the entire area statistical information table 132 transmits the statistical information in one day resulting from summing up of the position registration count at each time in one day for every MME to the eNB through the message transmission and reception section 131 every day (for example, at 00:00).

Upon reception of the message from the statistical information server 130, the interface 156 in the eNB 120 supplies the message to the message analyzer and editor 62. The message analyzer and editor 62 analyzes the message and, if the message is the statistical information in one day, supplies the statistical information in one day to the destination MME selection controller 64. In S195, the destination MME selection controller 64 updates the position registration count statistical information graph 122.

S194 in FIG. 37 corresponds to S157 in FIG. 36.

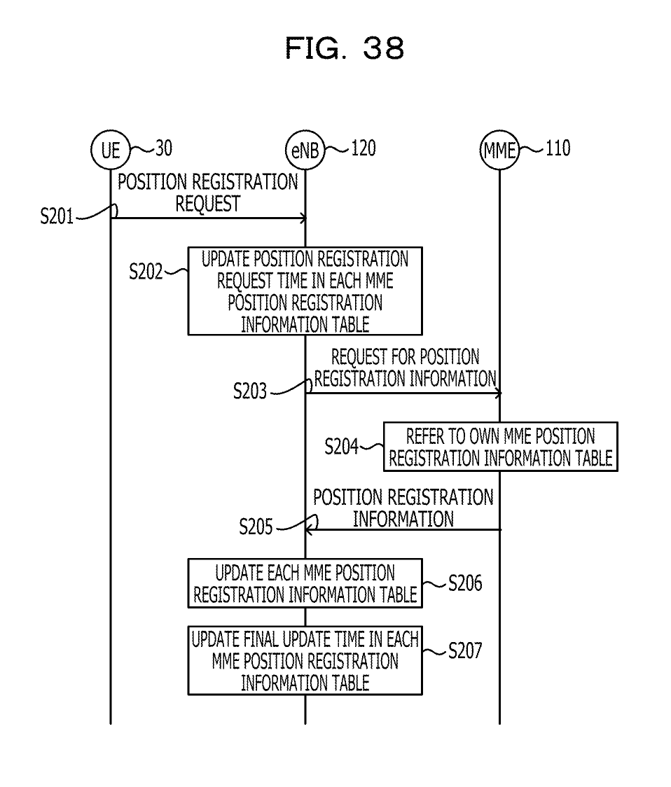

FIG. 38 is a sequence chart illustrating an operational process of acquiring the position registration information in the eNB when the position registration request is submitted in the fourth embodiment.

Referring to FIG. 38, in S201, the eNB 120 receives a message transmitted from the UE 30. The eNB 120 supplies the message to the message analyzer and editor 62 through the RF processing section 152, the AD converter 154, and the baseband processing section 61. The message analyzer and editor 62 analyzes the supplied message and, if the analysis indicates that the message is the position registration request, supplies the position registration request to the destination MME selection controller 64.

In S202, the destination MME selection controller 64 calculates the time when the position registration request is notified from the UE 30 and updates the position registration request time 74 in the each MME position registration information table 121 to the calculated time.

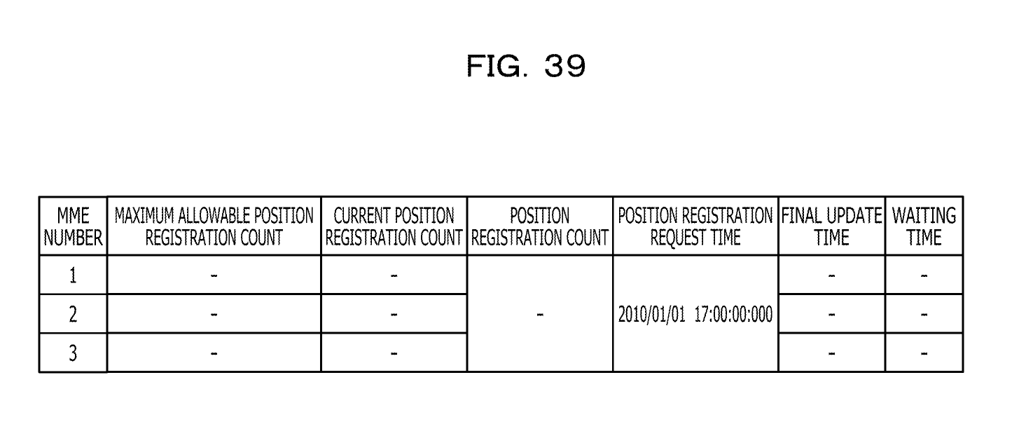

FIG. 39 illustrates an example of the each MME position registration information table 121 when the first position registration request is received in S202. In the example in FIG. 39, the position registration request is notified from the UE 31 at Jan. 1, 2010 17:00:00:000.

The destination MME selection controller 64 indicates to the message analyzer and editor 62 that the position registration request is notified.

In S203, the message analyzer and editor 62 edits the message and transmits the request for the position registration information to the MME 110 establishing the S1 interface through the interface 156.

Upon reception of the message transmitted from the eNB 120, the message transmission and reception section 41 in the MME 110 supplies the message to the message analyzer and editor 42. The message analyzer and editor 42 analyzes the supplied message. If the analysis indicates that the message is the request for the position registration information, the message analyzer and editor 42 inquires of the position registration count manager 43 about the position registration information indicating the position registration count of the own MME. In S204, upon reception of the inquiry, the position registration count manager 43 refers to the own MME position registration information table 44 and supplies the current position registration count 51 and the maximum allowable position registration count 52 in the own MME to the message analyzer and editor 42.

In S205, the message analyzer and editor 42 transmits the position registration information including the current position registration count 51 and the maximum allowable position registration count 52 to the eNB 120 through the message transmission and reception section 41.

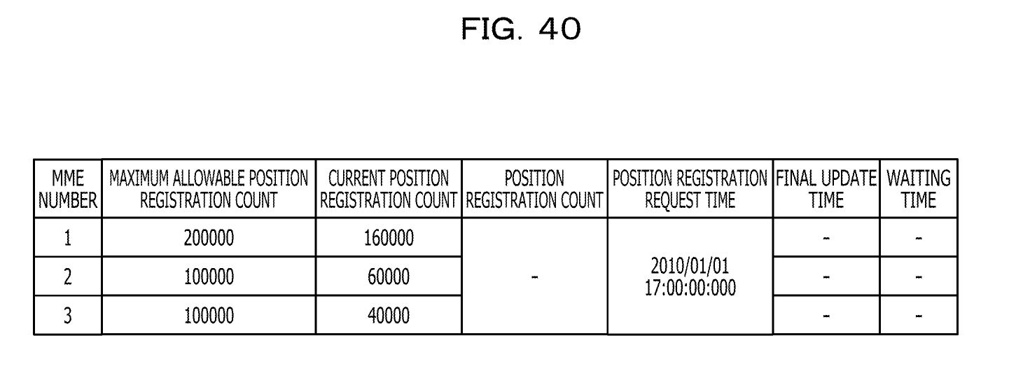

The interface 156 in the eNB 120 supplies the message received from the MME 110 to the message analyzer and editor 62. The message analyzer and editor 62 analyzes the supplied message and, if the message is the position registration information, extracts the current position registration count 51 and the maximum allowable position registration count 52 from the position registration information and supplies the extracted information to the MME position registration count manager 63. In S206, the MME position registration count manager 63 updates the each MME position registration information table 121 for every MME based on the information supplied from the message analyzer and editor 62. FIG. 40 illustrates an example of the each MME position registration information table 121 in S206.

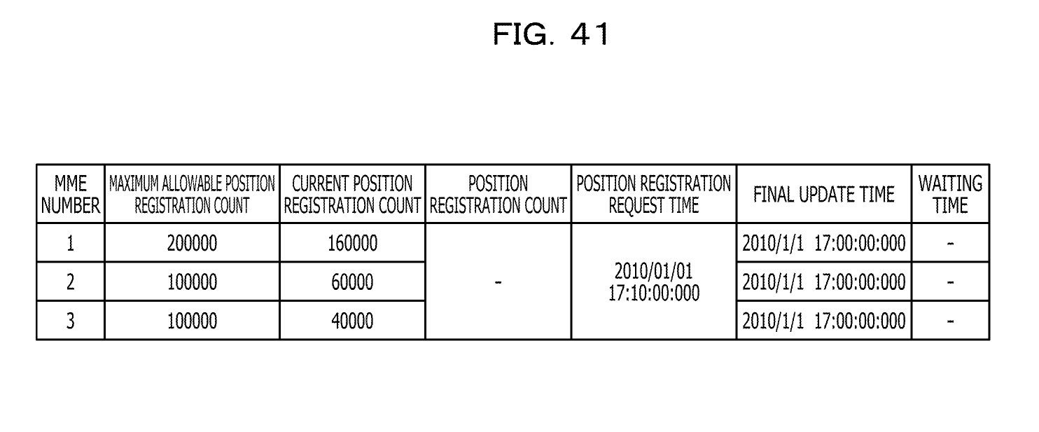

In S207, the MME position registration count manager 63 calculates the time when the position registration information is received and updates the final update time 75 in the each MME position registration information table 121 to the calculated time. FIG. 41 illustrates an example of the each MME position registration information table 121 in S207.

For example, the each MME position registration information table 121 in FIG. 41 indicates that the eNB connected to the MMEs #1, #2, and #3 received the position registration information from each MME at Jan. 1, 2010 17:10:00:000. The MME #1 may register up to 200,000 positions and 160,000 positions are registered at Jan. 1, 2010 17:00:00:000 in the example in FIG. 41.

S201 in FIG. 38 corresponds to S158 and S168 in FIG. 36, S203 in FIG. 38 corresponds to S159, S161, S163, S169, and S171 in FIG. 36, and S205 in FIG. 38 corresponds to S160, S162, S164, S170, and S172 in FIG. 36.

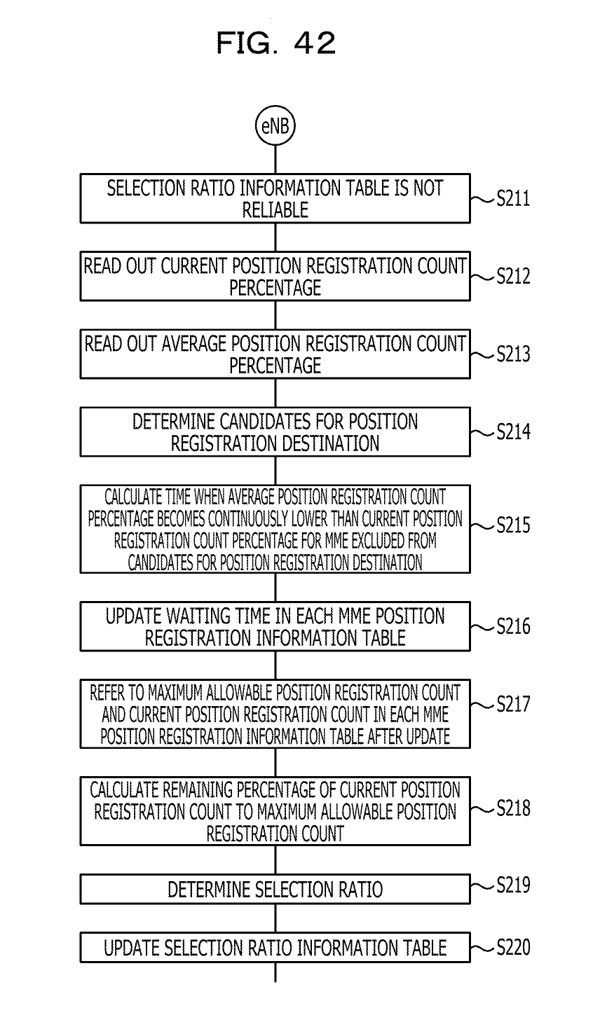

FIG. 42 is a sequence chart illustrating an operational process of determining the selection ratio of the MME in the fourth embodiment.

Referring to FIG. 42, in S211, the destination MME selection controller 64 determines that the position registration request time 74 is at least a given time before the final update time 75 before the notification of the position registration requests of a given number is completed. In this case, the destination MME selection controller 64 determines that the selection ratio information table 66 is not reliable because the current selection ratio information table 66 is not up-to-date.

In S212, the destination MME selection controller 64 reads out a current position registration count percentage (hereinafter referred to as A) of the current position registration count 73 to the maximum allowable position registration count 72 of the MME 110 from the each MME position registration information table 121.

In S213, the destination MME selection controller 64 reads out the average position registration count percentage 126 (hereinafter referred to as B) at the final update time 75 in the position registration count statistical information graph 122.

In S214, the destination MME selection controller 64 compares A with B and determines that the MME 110 whose B is higher than A is excluded from the candidates for the MME to be notified of the position registration request.

In S215, the destination MME selection controller 64 calculates the time when the B becomes continuously lower than A for the excluded MME 110.

In S216, the destination MME selection controller 64 reflects the calculated time in the waiting time 125 in the each MME position registration information table 121.

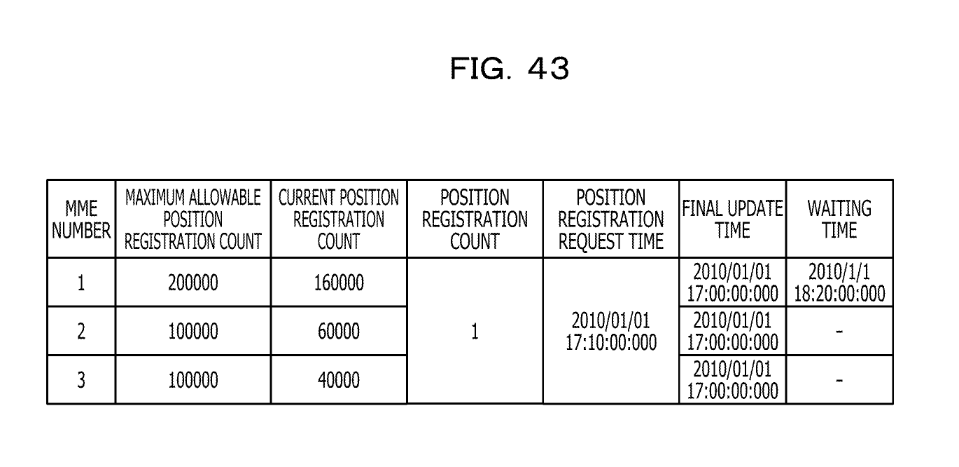

For example, FIG. 43 illustrates an example of the each MME position registration information table 121 in S216. A method of determining the MME to be excluded from the candidates for the MME to be notified of the position registration request will now be described with reference to FIG. 33 and FIG. 43. Referring to FIG. 33, the horizontal axis represents time and the vertical axis represents the average position registration count percentage (the percentage of the average position registration count to the maximum allowable position registration count). As illustrated in FIG. 33, the average position registration count percentage in the MME #1 at 17:10:00:000 is higher than the current position registration count percentage in the MME #1 (the percentage of the current position registration count to the maximum allowable position registration count). In the graph in FIG. 33, the current position registration count percentage of MME #1 is 80% and is denoted by a line a. The average position registration count subsequently tends to increase and the current position registration count of the MME #1 becomes lower than the average position registration count after about 18:20. Accordingly, the MME #1 is excluded from the candidates for the MME to be notified of the position registration request and “Jan. 1, 2010 18:20:00:000” is set as the waiting time.

Since the position registration count percentage in the MME #2 at 17:10:00:000 is about 60% and the average position registration count percentage is lower than the position registration count percentage, the MME #2 is included in the candidates for the MME to be notified of the position registration request. Since the position registration count percentage in the MME #3 at 17:10:00:000 is about 40% and the average position registration count percentage is lower than the position registration count percentage, the MME #3 is included in the candidates for the MME to be notified of the position registration request.

Referring back to FIG. 42, upon reception of the position registration request from the UE 30, the destination MME selection controller 64 acquires the position registration information from the MME other than the excluded MME 110 and updates the each MME position registration information table 121. Then, in S217, the destination MME selection controller 64 refers to the maximum allowable position registration count 72 and the current position registration count 73 of each MME in the each MME position registration information table 121. In S218, the destination MME selection controller 64 calculates the remaining percentage of the current position registration count 73 to the maximum allowable position registration count 72 of each MME.

For example, the MME #1 is excluded from the candidates for the position registration destination in the example in FIG. 43. The calculation of the remaining percentage of the current position registration count 73 to the maximum allowable position registration count 72 of each MME results in MME #1=0, MME #2=0.4, and MME #3=0.6. S217 and S218 are performed for all the MMEs establishing the S1 interface with the eNB, other than the MME excluded from the candidates for the position registration destination.

In S219, the destination MME selection controller 64 determines the selection ratio in the selection of the MME to be notified of the position registration request so that the remaining percentage of the position registration count is uniformly balanced between the respective MMEs.

For example, the selection ratio may be determined in a manner described below.

Calculation of the proportion of the remaining percentages calculated for the respective MMEs in order to determine the selection ratio results in the MME #1:the MME #2:the MME #3=0:0.4:0.6=0:2:3.

The MME to be notified of the position registration request is selected based on this proportion. In the above example, if the position registration requests corresponding to five calls are submitted, zero calls are allocated to the MME #1, two calls are allocated to the MME #2, and three calls are allocated to the MME #3.

In S220, the destination MME selection controller 64 updates the selection ratio information table 66 based on the calculated selection ratio.

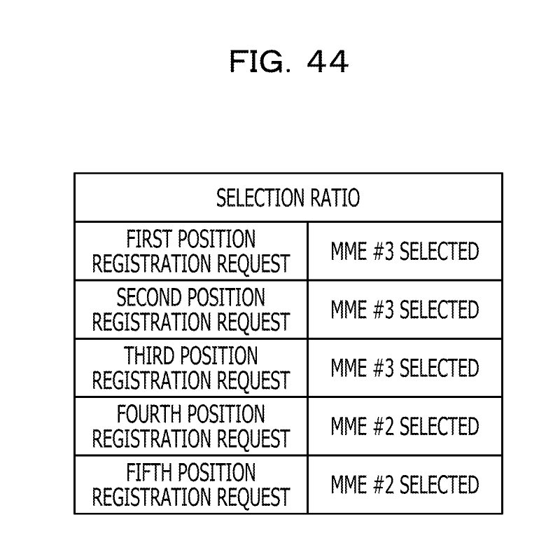

FIG. 44 illustrates an example of the selection ratio information table 66 in S220.

The MMEs may be selected in descending order of the selection ratio or the selection order may not be determined.

The determination of the selection ratio, the update of the selection ratio information table 66, etc. described above are performed, for example, when the waiting time elapsed and when the notification of the position registration requests of a given number is completed.

S214 in FIG. 42 corresponds to S167 in FIG. 36 and S219 in FIG. 42 corresponds to S173 in FIG. 36.

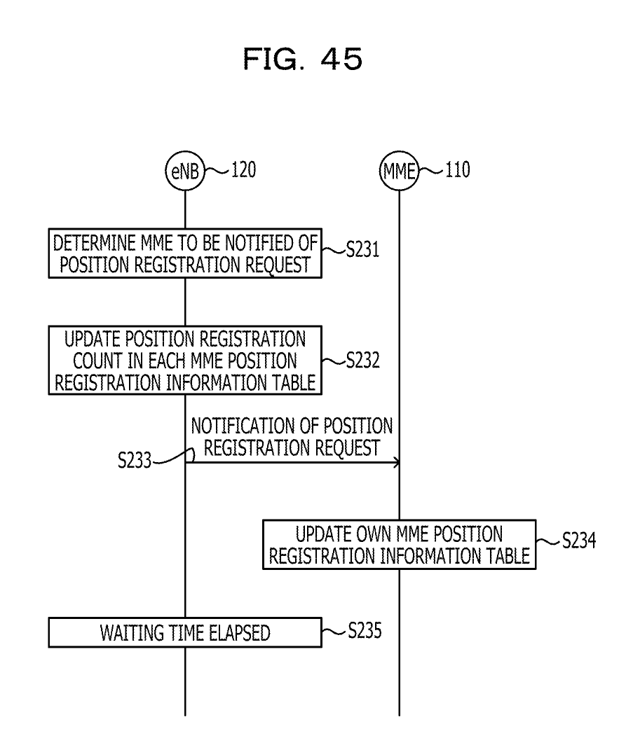

FIG. 45 is a sequence chart illustrating a position registration operation in the eNB in the fourth embodiment.

Referring to FIG. 45, in S231, the destination MME selection controller 64 selects the MME to be notified of the position registration request received from the UE based on the selection ratio information table 66 and supplies the MME number of the selected MME to be notified of the position registration request to the message analyzer and editor 62.

In S232, the destination MME selection controller 64 updates the position registration count 102 in the each MME position registration information table 121.

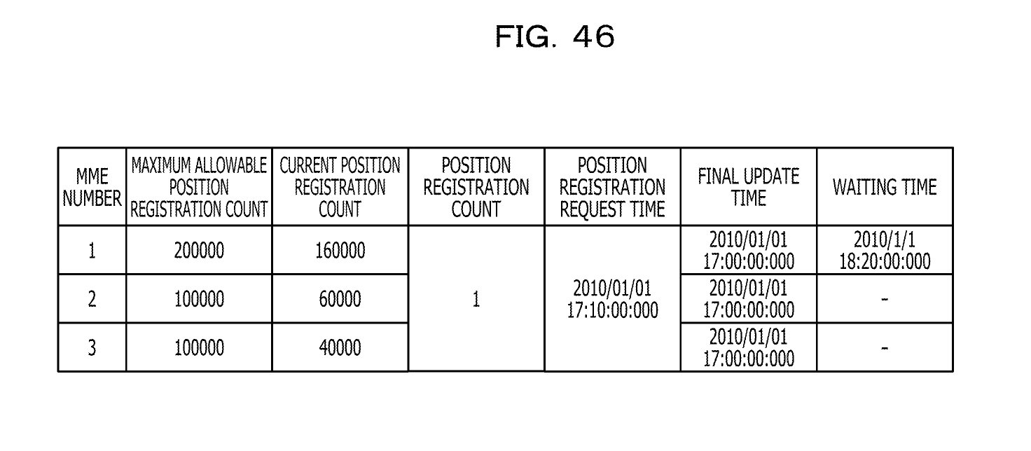

FIG. 46 illustrates an example of the each MME position registration information table 121 in S232.

Upon reception of the MME number of the MME to be notified of the position registration request, the message analyzer and editor 62 edits the message for the MME indicated by the MME number and supplies the edited message to the interface 156 as the position registration request. In S233, the interface 156 transmits the supplied position registration request to the selected MME.

Upon reception of the message from the eNB 120, the message transmission and reception section 41 in the MME 110 supplies the message to the message analyzer and editor 42. The message analyzer and editor 42 analyzes the message and, if the message is the position registration request, supplies the position registration request to the position registration count manager 43.

In S234, the position registration count manager 43 updates the own MME position registration information table 44 based on the supplied position registration request.

In S235, the destination MME selection controller 64 in the eNB 120 refers to the position registration count 102 in the each MME position registration information table 121 and, when the position registration has been performed a given number of times or when the waiting time 125 of the MME excluded from the candidates for the MME to be notified of the position registration request elapsed, stops the selection of the MME to be notified of the position registration request by using the current selection ratio information table 66.

S231 in FIG. 45 corresponds to S165 and S173 in FIG. 36, S233 in FIG. 45 corresponds to S166, S174, S176, S178, S180, and S182 in FIG. 36, and S235 in FIG. 45 corresponds to S183 in FIG. 36.

According to the fourth embodiment, even if a given time elapsed since the selection ratio of the MME to be notified of the position registration request was determined and the position registration information received from each MME is not up-to-date, it is possible to select the optimal MME to be notified of the position registration request based on the statistical information indicating the position registration count previously summed up.

### Fifth Embodiment

In a fifth embodiment, each base station receives statistical information indicating the statistical value of the processing load on each higher-level station, selects higher-level stations to be notified of position registration requests based on the statistical information, and notifies the higher-level stations of the position registration requests based on the result of the selection to realize the load balancing between the multiple higher-level stations. Alternatively, the base station compares the load information with the statistical information, determines whether the load information or the statistical information is used based on the result of the comparison, and selects higher-level stations to be notified of a position registration request that is received and position registration requests that are subsequently received based on the determined information to realize the load balancing between the multiple higher-level stations.

Although each MME, each eNB, and each piece of UE are described as examples of the higher-level station, the base station, and the mobile station, respectively, the position registration information indicating the position registration count in each MME is described as an example of the load information, and information indicating the statistical value of the position registration count summed up in each MME is described as an example of the statistical information in the following description, the processing load on each MME is not limited to the position registration count.

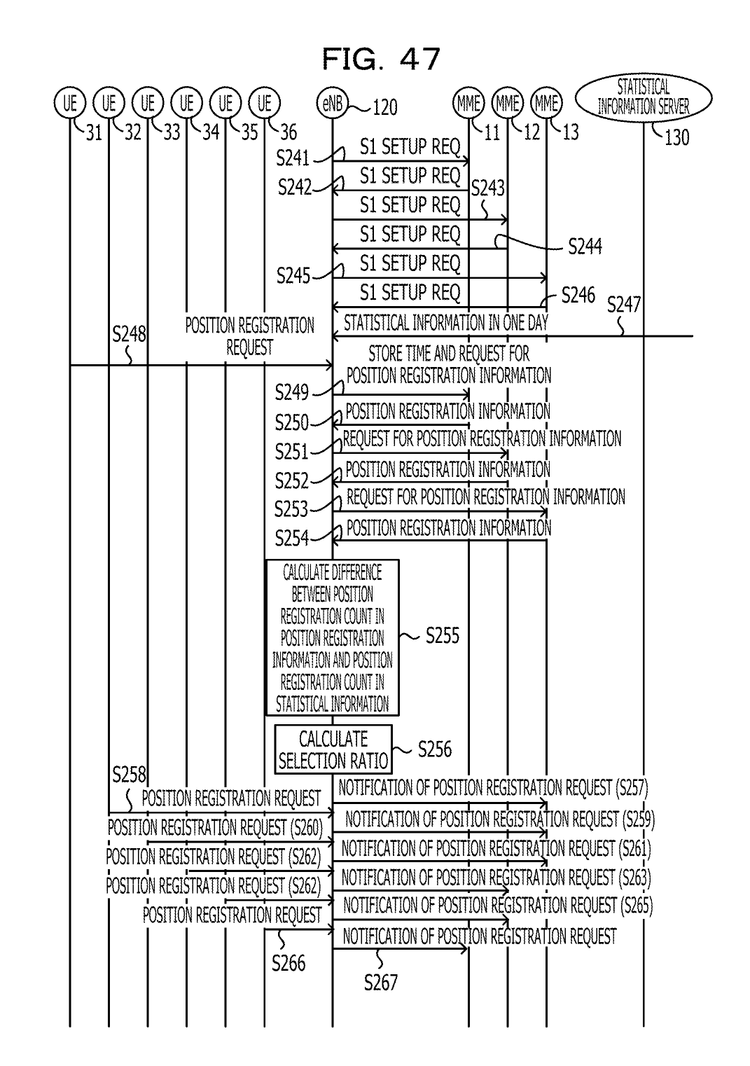

The fifth embodiment will now be described with reference to FIG. 47. A base station, a communication system, and a communication method according to the fifth embodiment are only specific examples and the fifth embodiment differs from the fourth embodiment in that how the statistical information indicating the statistical value of the position registration count is used. The entire area to which the fifth embodiment is applied, the own MME position registration information table, the each MME position registration information table, the selection ratio information table, the diagram illustrating the hardware configuration and the functional block diagram of the MME, the diagram illustrating the hardware configuration and the functional block diagram of the eNB, the position registration count statistical information graph, the diagram illustrating the hardware configuration and the functional block diagram of the statistical information server, the entire area statistical information table in the statistical information server, the sequence chart in the acquisition of the statistical information, and the sequence chart in the acquisition of the position registration information are the same as the ones illustrated in FIG. 2, FIG. 4, FIG. 6, FIG. 7, FIG. 30 to FIG. 35, FIG. 37, and FIG. 38. The same reference numerals are used in the fifth embodiment to identify the same components as in the first to fourth embodiments. A description of such components is omitted herein.

In the fifth embodiment, upon notification of the first position registration request from the UE 31, the destination MME selection controller 64 in the eNB 120 inquires of the MMEs 11 to in establishing the S1 interface about the position registration information indicating the position registration counts. Then, the destination MME selection controller 64 calculates the difference between the position registration count at the current time in the statistical information indicating the statistical value of the position registration count at each time managed in each MME and the position registration count in the position registration information about which the eNB 120 has inquired of each MME. The destination MME selection controller 64 selects the MMEs to be notified of the subsequent position registration requests by using the statistical information if the difference is smaller than a threshold value, and calculates the selection ratio by using the position registration information received from each MME, as in the first to third embodiments, if the difference is larger than or equal to the threshold value. The destination MME selection controller 64 notifies the MMEs of the position registration requests based on the result of the calculation.

Alternatively, the destination MME selection controller 64 may notify the MME of the position registration request based on the statistical information upon reception of the statistical information by the eNB 120.

FIG. 47 is a sequence chart in the fifth embodiment.

Referring to FIG. 47, in S241, the eNB 120 transmits an S1 interface establishment request (S1 SETUP REQ) to the MME 11.

In S242, the MME 11 returns an S1 interface establishment response (S1 SETUP RES) to the eNB 120 upon reception of the S1 interface establishment request (S1 SETUP REQ) from the eNB 120 to establish an S1 interface.

In S243, the eNB 120 transmits the S1 interface establishment request (S1 SETUP REQ) to the MME 12.

In S244, the MME 12 returns the S1 interface establishment response (S1 SETUP RES) to the eNB 120 upon reception of the S1 interface establishment request (S1 SETUP REQ) from the eNB 120 to establish the S1 interface.

In S245, the eNB 120 transmits the S1 interface establishment request (S1 SETUP REQ) to the MME 13.

In S246, the MME 13 returns the S1 interface establishment response (S1 SETUP RES) to the eNB 120 upon reception of the S1 interface establishment request (S1 SETUP REQ) from the eNB 120 to establish the S1 interface. As in the first to fourth embodiments, the eNB 120 achieves the S1-Flex function through S241 to S246.

In S247, the statistical information server 130 transmits the statistical information in one day indicating the statistical information about the position registration count at each time in the MME 110 establishing the S1 interface with the eNB 120 periodically (for example, every day). The statistical information in one day is the value in the entire area statistical information table 132 in the statistical information server 130, as in the fourth embodiment. At this time, the eNB 120 updates the position registration count statistical information graph 122 with the statistical information in one day received from the statistical information server 130.

In S248, the eNB 120 receives the position registration request from the UE 31. In S249, the eNB 120 stores the time when the position registration request is received from the UE 31 and inquires of the MME 11 about the position registration information indicating the position registration count.

In S250, the MME 11 notifies the eNB 120 of the position registration information including the maximum allowable position registration count and the current position registration count.

In S251, the eNB 120 inquires of the MME 12 about the position registration information indicating the position registration count.

In S252, the MME 12 notifies the eNB 120 of the position registration information including the maximum allowable position registration count and the current position registration count.

In S253, the eNB 120 inquires of the MME 13 about the position registration information indicating the position registration count.

In S254, the MME 13 notifies the eNB 120 of the position registration information including the maximum allowable position registration count and the current position registration count.

In S255, upon notification of the position registration information indicating the position registration counts from all the MMEs establishing the S1 interface with the eNB 120, the eNB 120 calculates the difference between the position registration count of each MME in the notified position registration information and the position registration count at the corresponding time in the position registration count statistical information graph 122 to confirm whether the difference is smaller than a threshold value. If the difference is smaller than the threshold value, the eNB 120 determines that the position registration count statistical information graph 122 is reliable. Accordingly, the eNB 120 may select the MMEs to be notified of the subsequent position registration requests by using the position registration count statistical information graph 122 to decrease the number of times when each MME is notified of the position registration information. Alternatively, the eNB 120 may use the statistical information without calculating the above difference.

The eNB 120 determines that the position registration count statistical information graph 122 is reliable if the difference is smaller than the threshold value. However, if the difference is larger than or equal to the threshold value, the eNB 120 may calculate the selection ratio based on the position registration information indicating the position registration count received from each MME, as in the other embodiments, to select the MMEs to be notified of the position registration requests based on the result of the calculation.

In S256, the eNB 120 refers to the position registration count percentage in the statistical information indicating the position registration count at each time in each MME in the position registration count statistical information graph 122 to calculate the selection ratio in the selection of the MME to be notified of the position registration request in accordance with the position registration count percentage. For example, if the remaining position registration count percentage of MME #1=0.2, the registration count percentage of MME #2=0.4, and the position registration count percentage of MME #3=0.6, the selection ratio is MME #1:MME #2:MME #3=0.2:0.4:0.6=1:2:3.

In S257, the eNB 120 notifies the selected MME of the position registration request from the UE 31 based on the result of the calculation. For example, if the selection ratio is MME #1:MME #2:MME #3=1:2:3, the eNB 120 notifies the MME 13 of the position registration request from the UE 31.

In S258 to S267, the eNB 120 notifies the selected MMEs of the position registration requests in accordance with the calculated selection ratio for a given time. For example, it is assumed that the UE 32, the UE 33, the UE 34, the UE 35, and the UE 36 sequentially notify the eNB 120 of the position registration requests. In this case, the eNB 120 notifies the MME 13 of the position registration requests from the UE 32 and the UE 33, like the position registration request from the UE 31, notifies the MME 12 of the position registration requests from the UE 34 and the UE 35, and notifies the MME 11 of the position registration request from the UE 36.

The calculation of the selection ratio in the selection of the MME to be notified of the position registration request may be periodically performed based on the statistical information indicating the position registration count summed up at each time to select the optimal MME to be notified of the position registration request.

In addition, if the difference between the statistical information indicating the statistical value of the position registration count in each MME and the position registration information indicating the position registration count in each MME is larger than a given threshold value, the processing operations in the first to fourth embodiments may be performed in the selection of the MME to be notified of the position registration request in accordance with the position registration information indicating the position registration count received from each MME to combine the fifth embodiment with the first to fourth embodiments.

According to the fifth embodiment, since the number of times when the eNB requests the transmission of the position registration information indicating the position registration count from the MME and the number of times when the MME transmits the position registration information may be decreased, it is possible to reduce the load on the eNBs and the MMEs.

According to the base station, the communication system, and the communication method in the first to fifth embodiments, it is possible to realize the load balancing between the multiple higher-level stations that perform complicated processing and that control the multiple base stations without causing each higher-level station to monitor the load statuses of the other higher-level stations.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A base station comprising:
a transmission and reception section configured to receive a position registration request transmitted from a mobile station, and receive load information indicating a load of processing in each of a plurality of higher-level stations, transmitted from each of the plurality of higher-level stations which are connected to the base station; and
a control section configured to select a higher-level station to be notified of the position registration request based on the load information, the position registration request being notified to the selected higher-level station by the transmission and reception section.

2. The base station according to claim 1,
wherein the control section instructs the plurality of higher-level stations to transmit the load information.

3. The base station according to claim 2, further comprising:
a buffer configured to hold the position registration request received by the transmission and reception section and a position registration request that is subsequently received,
wherein the control section instructs the plurality of higher-level stations to transmit the load information when a given time elapsed since the holding of the position registration request in the buffer has been started and selects higher-level stations to be notified of the position registration requests that are held from the plurality of higher-level stations based on the load information received in response to the transmission instruction.

4. The base station according to claim 2, further comprising:
a buffer configured to hold the position registration request received by the transmission and reception section and a position registration request that is subsequently received,
wherein the control section instructs the plurality of higher-level stations to transmit the load information when the number of the position registration requests that are held reaches a given number and selects higher-level stations to be notified of the position registration requests that are held from the plurality of higher-level stations based on the load information received in response to the transmission instruction.

5. The base station according to claim 2,
wherein the control section instructs the plurality of higher-level stations to transmit the load information upon start of the reception of the position registration request in the transmission and reception section and selects higher-level stations to be notified of the position registration request that is received and a position registration request that is subsequently received from the plurality of higher-level stations based on the load information received in response to the reception instruction.

6. The base station according to claim 5,
wherein the control section selects higher-level stations to be notified of the position registration requests received for a given time since the reception of the position registration request has been started in the transmission and reception section based on the load information received in response to the transmission instruction.

7. The base station according to claim 5,
wherein the control section selects higher-level stations to be notified of the position registration requests of a given number received after the reception of the position registration request is started in the transmission and reception section based on the load information received in response to the transmission instruction.

8. The base station according to claim 3,
wherein the control section calculates a selection ratio in the selection of a higher-level station to be notified of the position registration request that is received based on the load information received from each of the higher-level stations and selects higher-level stations to be notified of the position registration request that is received and the position registration request that is subsequently received based on the calculated selection ratio.

9. The base station according to claim 1,
wherein the transmission and reception section receives statistical information indicating a statistical value of a load of processing in each of the higher-level stations, and
wherein the control section selects a higher-level station to be notified of the position registration request based on the statistical information.

10. The base station according to claim 9,
wherein the control section compares the load information with the statistical information, determines whether the statistical information is used based on the result of the comparison, and selects higher-level stations to be notified of the position registration request that is received and the position registration request that is subsequently received based on either of the load information and the statistical information.

11. A communication method comprising:
transmitting a position registration request by a mobile station that communicates with a base station connected to a plurality of higher-level stations;
transmitting load information indicating a load of processing in each higher-level station by each of the plurality of higher-level stations;
receiving the position registration request transmitted from the mobile station and the load information transmitted from each of the plurality of higher-level station by the base station;
selecting a higher-level station to be notified of the position registration request based on the load information by the base station; and
notifying the selected higher-level station of the position registration request by the base station.

12. The communication method according to claim 11,
wherein the base station instructs the plurality of higher-level stations to transmit the load information.

13. The communication method according to claim 12,
wherein the base station holds the position registration request that is received and a position registration request that is subsequently received, and
wherein the selecting instructs the plurality of higher-level stations to transmit the load information when a given time elapsed since the holding of the position registration request has been started and selects higher-level stations to be notified of the position registration requests that are held from the plurality of higher-level stations based on the load information received in response to the transmission instruction.

14. The communication method according to claim 12,
wherein the base station holds the position registration request that is received and a position registration request that is subsequently received, and
wherein the selecting instructs the plurality of higher-level stations to transmit the load information when the number of the position registration requests that are held reaches a given number and selects higher-level stations to be notified of the position registration requests that are held from the plurality of higher-level stations based on the load information received in response to the transmission instruction.

15. The communication method according to claim 12,
wherein the selecting instructs the plurality of higher-level stations to transmit the load information upon start of the reception of the position registration request and selects higher-level stations to be notified of the position registration request that is received and a position registration request that is subsequently received from the plurality of higher-level stations based on the load information received in response to the reception instruction.

16. The communication method according to claim 15,
wherein the selecting selects higher-level stations to be notified of the position registration requests received for a given time since the reception of the position registration request has been started based on the load information received in response to the transmission instruction.

17. The communication method according to claim 15,
wherein the selecting selects higher-level stations to be notified of the position registration requests of a given number received after the reception of the position registration request is started based on the load information received in response to the transmission instruction.

18. The communication method according to claim 13,
wherein the selecting calculates a selection ratio in the selection of a higher-level station to be notified of the position registration request that is received based on the load information received from each of the higher-level stations and selects higher-level stations to be notified of the position registration request that is received and the position registration request that is subsequently received based on the calculated selection ratio.

19. The communication method according to claim 11,
wherein the receiving receives statistical information indicating a statistical value of a load of processing in each of the higher-level stations, and
wherein the selecting selects a higher-level station to be notified of the position registration request based on the statistical information.

20. The communication method according to claim 19,
wherein the selecting compares the load information with the statistical information, determines whether the statistical information is used based on the result of the comparison, and selects higher-level stations to be notified of the position registration request that is received and the position registration request that is subsequently received based on either of the load information and the statistical information.

21. A communication system comprising:
a mobile station configured to communicates a base station, the mobile station including
a first transmission section that transmits a position registration request;
a plurality of higher-level stations each including
a second transmission section that transmits load information indicating a load of processing in each higher-level station; and
the base station configured to be connected to the plurality of higher-level stations, the base station including
a transmission and reception section that receives the position registration request transmitted from the mobile station and the load information transmitted from each of the plurality of higher-level stations, and
a control section that selects a higher-level station to be notified of the position registration request based on the load information, the position registration request being notified to the selected higher-level station by the transmission and reception section.
